(19) United States
(12) Patent Application Publication
(10) Pub. No.: US 2024/0101355 A1
(43) Pub. Date: Mar. 28, 2024

(54) CROSS-BELT SORTER SYSTEM

(71) Applicant: Lewco, Inc., Sandusky, OH (US)

(72) Inventors: Gerald T. Guerra, Sandusky, OH (US); Art Jensen, West Palm Beach, FL (US); Ryan Kenny, Richmond, VA (US)

(21) Appl. No.: 18/476,242

(22) Filed: Sep. 27, 2023

Related U.S. Application Data
(60) Provisional application No. 63/410,739, filed on Sep. 28, 2022.

(51) Int. Cl. B65G 39/20; B65G 43/00

(52) U.S. Cl. CPC B65G 39/20; B65G 43/00

(57) ABSTRACT

A sorter system is configured to sort objects disposed on a conveying surface to a plurality of locations. The system includes a frame, a plurality of carriages each having a motor and a belt, a carriage power system, and a belt controller system. The carriage power system includes a plurality of circuit boards with first and second powerable strips. The belt controller system may cause the carriage power system to selectively power the first or second strips. The motors of carriages rolling along the strips may be powered to actuate the belt. The motors may actuate the belt in a first direction when the first strip is powered and actuate the belt in a second direction when the second strip is powered.

### RELATED APPLICATION

This application claims priority to United States Provisional Patent Application No. 63/410,739, filed on Sep. 28, 2022, and entitled “CROSS-BELT SORTER SYSTEM”, the entirety of which is incorporated herein by reference.

### TECHNICAL FIELD

The present application relates generally to conveyor systems and, more particularly, to cross-belt systems having belts that are independently moveable in both directions perpendicular to a conveying surface.

### BACKGROUND OF THE INVENTION

Conveyor systems have been used in a variety of locations, such as warehouses and distribution centers, to more efficiently move or convey objects or packages, such as to prepare the objects or packages for sorting or shipment. The conveyor systems may have a conveying surface which directs the packages toward a destination, such as via belts, rollers, or gravity.

Sorter systems have been included in conveyor systems to direct packages into one of a plurality of locations or groups based upon the package, such as based upon the shipping destination of the package. Sorter systems include a conveying surface that is belt-, roller-, or gravity-fed to convey the packages along the conveying surface, one or more chutes extending from one or more sides of the conveying surface, and one or more mechanisms to divert the packages into the one or more chutes. The sorting systems may be implemented at the end of the conveyor system with multiple chutes extending from the conveying surface to sort the conveyed packages, such as by shipping location. However, the sorting systems may also be used as the start or in the middle of conveyor systems, such as to divert packages between two or more conveyor paths.

Conventionally, the sorter systems implement either a shoe sorter or a cross-belt (or over-under) sorter to move the packages conveyed along the conveying surface into a desired chute, such that the packages may be sorted and grouped together. Conventionally, the chutes are gravity fed, have a width between about 24 inches and about 76 inches, and may include a bin or container at the end of the chute for receiving the packages. The chutes may lead to sorting areas based upon a number of features, such as the package destination, such as by destination zip code.

Shoe sorters include one or more actuation elements, such as rods, sticks, or pucks, disposed at a height above the conveying surface which may be moved or actuated across the conveying surface to hit or otherwise move packages into one of the chutes. Generally, shoe sorters include chutes along only one side of the conveyor system, such as because with the conveying surface of the shoe sorter being a continuous horizontal loop that may continuously convey packages until directed into a chute by an actuation element. The actuation elements are disposed on the side of the conveying surface opposite the chutes and are laterally actuated toward the chutes when the packages pass the destination chute or receptacle, thereby moving the package to the destination chute or receptacle. The actuation elements may be fixed on the frame of the sorter and laterally or pivotably actuated across the conveying surface or the actuation elements may be disposed on the conveying surface and conveyed along the surface and moved across the conveying surface at the destination chute or receptacle. When the actuation elements are disposed on the conveying surface they are actuatable in only one direction while conveyed on the top of conveying surface and must be reset by a mechanism to move the actuation element back to the starting position. Due to the configuration of the sorter, chutes can be disposed only on one side of the conveying surface and packages cannot be placed on the conveying surface past the beginning of the sorter, thereby reducing the total number of chutes and the efficiency, versatility, and throughput of the system.

Other shoe sorters include chutes on both sides of the conveying surface and the actuation elements are disposed along the center of the conveying surface. Packages may be placed on either side of the actuation elements and the actuation elements may be actuated to either side of the conveying surface to move the package to the destination chute or receptacle. However, the actuation elements may only move packages into chutes on the same side of the actuation element as the chute so the packages must be pre-sorted onto the conveying surface on either side of the actuation elements, thereby reducing the efficiency and throughput of the system. Additionally, after actuation, the actuation elements must also be reset by a mechanism past the end of the conveyor to move the actuation elements back to the center of the conveying surface. Further, two-directional shoe sorters require larger widths to convey the package (e.g., requiring suitable space on both sides of the actuation elements), thereby increasing the footprint of the sorter system.

Further, the actuation elements of the shoe sorters generally extend a short distance above the conveying surface. Therefore, the actuation elements may have not effectively move smaller, lighter, or less dense and/or amorphous packages as the actuation elements may simply slide underneath the package. For example, the actuation elements may slide under a light, bag-type package on the conveying surface.

Cross-belt or over-under belt sorters include a plurality of carriages or carts formed into a loop which rotate along the conveying surface of the sorter. The carriages include a belt looped around the carriage and oriented perpendicularly to the conveying direction of the conveying surface. Packages are placed across one or more carriages and, when the package passes the destination chute or receptacle, the belt of the carriage(s) are actuated in either direction toward the destination chute or receptacle. Conventionally, it is difficult, complicated, and expensive to supply power to the carts because they are moving along the sorter, such as including an inductive magnet system or power take-ups on the side of the carriage. Additionally, the carriages may be prone to mechanical failures due to the power source, complexity, and number of parts, and are difficult to repair due to their connection to the sorter. Further, the belts generally extend a length along the conveying surface corresponding to the widths of the chutes and move all packages placed thereon when actuated, so packages must be spaced apart along the length of the conveying surface, thereby reducing the efficiency and throughput of the system. Moreover, due to the configuration of electrical connections to each carriage required to actuate each belt, the carriages of conventional cross-belt sorters may be actuated only once per cycle and must be reset before actuating the belt again.

Accordingly, there is need for cross-belt sorter systems which permit packages to be conveyed along the conveyor system and properly moved to chutes or receptacles along the conveyor system without complicated power systems that are prone to failures and which permit packages to be placed on the conveying surface more efficiently.

### SUMMARY

The following is a brief summary of subject matter that is described in greater detail herein. This summary is not intended to be limiting as to the scope of the claims.

In one embodiment, a sorter system for sorting a package includes a frame with sides extending from a proximal end to a distal end, a track disposed between the frame sides in a looped configuration between the proximal end to the distal end, and a plurality of carriages disposed on the track. Each carriage includes a belt drive motor connected to a belt drive shaft, a belt drive roller, first and second belt support rollers, a belt disposed around the belt drive roller, the first belt support roller, and the second belt support roller, and first and second power receivers configured to direct power to the belt drive motor. The sorter system also includes a carriage power system including a plurality of circuit boards each including a first power strip and a second power strip, the first power strip being configured to contact the first power receiver of the carriage passing thereon and the second power strip being configured to contact the second power receiver of the carriage passing thereon. The sorter system further includes a belt controller system configured to generate a control signal to selectively power the first or second power strip of one or more circuit boards. The belt drive motors rotate the belt in a first direction when powered by a first power and rotate the belt in a second direction when powered by a second power.

In another embodiment, a belt drive system for a carriage of a sorter system includes a belt drive motor coupled to a belt drive shaft; a belt drive roller having an outer circumference and a belt receiving channel, a drive connector at least partially disposed around the drive belt shaft and received in the belt receiving channel, first and second belt support rollers disposed at an upper portion of the carriage, first and second power takeups configured to direct energy to the belt drive motor, and a belt disposed around the belt drive roller, the first belt support, and the second belt support. The belt drive motor actuates the belt drive shaft in a first direction when energized by the first power takeup and actuates the belt drive shaft in a second direction when energized by the second power takeup.

In another embodiment, a power system for a system including a plurality of carriages with belts includes a power source, a plurality of power sections electrically coupled with the power source and extending along a conductive track between side frames of the sorter system, each power section comprising a circuit board with a first power strip and a second power strip, and a belt controller system configured to selectively cause a first power level to be directed to the first power strips and a second power level to be directed to the second power strips. Each first power strip is configured to direct the first power level to one of the carriages passing thereon to actuate the belt of the carriage in a first direction and each second power strip is configured to direct the second power level to one of the carriages passing thereon to actuate the belt of the carriage in a second direction opposite the first direction.

The above summary presents a simplified summary to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later. A further understanding of the nature and advantages of the present disclosure are set forth in the following description and claims, particularly when considered in conjunction with the accompanying drawings in which like parts bear like reference numerals.

### BRIEF DESCRIPTION OF THE DRAWINGS

To further clarify various aspects of embodiments of the present disclosure, a more particular description of the certain embodiments will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale for all embodiments. Embodiments and other features and advantages of the present disclosure will be described and explained with additional specificity and detail through the use of the accompanying drawings in which:

FIG. 1 illustrates a top perspective view of a sorter system according to one example;

FIG. 2 illustrates a top perspective view of the sorter system of FIG. 1 with a plurality of chutes;

FIG. 3 illustrates a top perspective view of a sorter system according to another example;

FIG. 4 illustrates a front view of the sorter system of FIG. 4;

FIG. 5 illustrates a side view of the sorter system of FIG. 4;

FIG. 6 illustrates a cut-away perspective view of a proximal end of the sorter system of FIG. 4;

FIG. 7 illustrates another perspective view of the proximal end of the sorter system of FIG. 4;

FIG. 8 illustrates a cut-away side view of the sorter system of FIG. 4;

FIGS. 9 and 10 illustrates perspective views of an example carriage for use with the sorter system of FIG. 4;

FIG. 11 illustrates a side view of the carriage of FIGS. 9 and 10;

FIGS. 12 and 13 illustrate exploded perspective views of the carriage of FIGS. 9 and 10;

FIGS. 14 and 15 illustrate perspective views of the carriage of FIGS. 9 and 10 with carriage frames removed;

FIG. 16 illustrates a side view of the carriage of FIGS. 14 and 15;

FIGS. 17 and 18 illustrate perspective views of an example carriage drive system for use with the carriages of FIGS. 9-16;

FIG. 19 illustrates a side view of the carriage drive system of FIGS. 17 and 18; and

FIG. 20 illustrates a perspective view of an example circuit board for use with the sorter system of FIGS. 3-8;

FIG. 21 illustrates a rear view of the circuit board of FIG. 20;

FIG. 22 illustrates a bottom perspective cut-away view of a drive system for sue with the sorter system of FIGS. 3-8;

FIGS. 23 and 24 illustrate perspective views of example wheels and power intakes for a carriage for use in a sorter system;

FIG. 25 illustrates a functional block diagram of a sorter control system; and

FIG. 26 illustrates a flow diagram of a method for generating controlling a position and orientation of a package in a sorter system.

### DETAILED DESCRIPTION

The following description refers to the accompanying drawings, which illustrate specific embodiments of the present disclosure. Other embodiments having different structures and operation do not depart from the scope of the present disclosure.

Described herein are various technologies pertaining to a sorter system that includes a plurality of carriages with belts, a sorter power system, and a belt controller system. The carriages include a belt drive system configured to decrease the width of the carriage and/or the belt and a belt power system configured to provide differing power levels or polarities to the belt drive system. The belt drive system may actuate the belt of the carriage in either a first direction or a second direction based upon the received power, such as actuating the belt in a first direction when power with a first polarity is received and actuating the belt in a second direction when power with a second polarity opposite the first polarity is received. The belt power system may selectively transmit power to the belt power systems of one or more carriages defining a conveying surface of the sorter system with differing power levels or polarities. The belt controller system may be disposed remotely from the carriages and sorter power system and be configured to generate control signals causing differing power levels or polarities to be transmitted to one or more carriages defining the conveying surface.

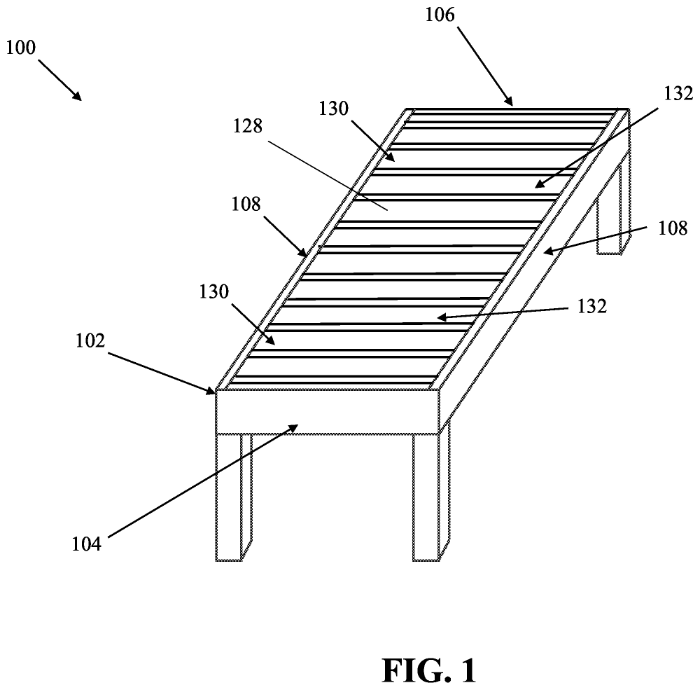

Referring to FIG. 1, a package conveyor or sorter system 100 is depicted according to one embodiment. The conveyor system 100 includes a frame 102 extending from a proximal end 104 to a distal end 106 opposite the proximal end 104, frame sides 108 on each side of the frame 102, and a plurality of carts or carriages 130 disposed between the frame sides 108 along a length of the conveyor system 100 substantially extending from the proximal end 104 to the distal end 106.

In some embodiments, the frame 102 may include legs disposed on an underside of the frame 102 and wheels disposed at the end of the legs such that the sorter system 100 may be moved or otherwise positioned, such as on a floor. In the illustrated embodiment, the sorter system 100 is linear. However, the sorter system 100 may have other suitable shapes or configurations. For example, the sorter system 100 may be rounded, curved, serpentine, circular, etc.

The carriages 130 may be affixed to a track of the frame 102 in a looped configuration such that the carriages 130 may move from the proximal end 104 to the distal end 106 at a first height substantially equivalent to the top surface of the frame 102, move or rotate downwardly from the first height to a second height lower than the first height near the distal end 106, move from the distal end 106 to the proximal end 104 at the second height, and move or rotate upwardly from the second height to the first height near the proximal end 104. The top surfaces of the carriages 130 at the first height may define a conveying surface 128 for moving objects or packages along the sorter system 100 in a direction extending from the proximal end 104 to the distal end 106.

Each carriage 130 includes a carriage belt 132 disposed in a looped configuration around and/or within the carriage 130 and configured to rotate in a first and second directions perpendicular to the traveling direction of the conveying surface 128. The carriage belts 132 may be disposed around and/or within the carriages 130 such that a top portion of the carriage belt 132 at least partially defines the conveying surface 128. The carriage belts 132 may have a width extending in the direction between the proximal and distal ends 104, 106 that is substantially equal to or less than a width of the carriage 130 extending in the direction between the proximal and distal ends 104, 106. The widths of the carriages 130 and carriage belts 132 may be relatively narrow such that the conveying surface 128 may be defined by many carriages 130 and/or carriage belts 132. Additionally, the widths of the belts 132 may be relatively equal to the widths of the carriages 130 such that substantially any point along the conveying surface 128 may be actuated in the first or second direction. Due to the widths of the carriages 130 and/or the belts 132 the position, location, and/or orientation of packages disposed on the conveying surface 128 may be controlled more precisely, as discussed below. For example, the carriages 130 may have a width of about 6 inches and the carriage belts 132 may have a width of about 5 inches.

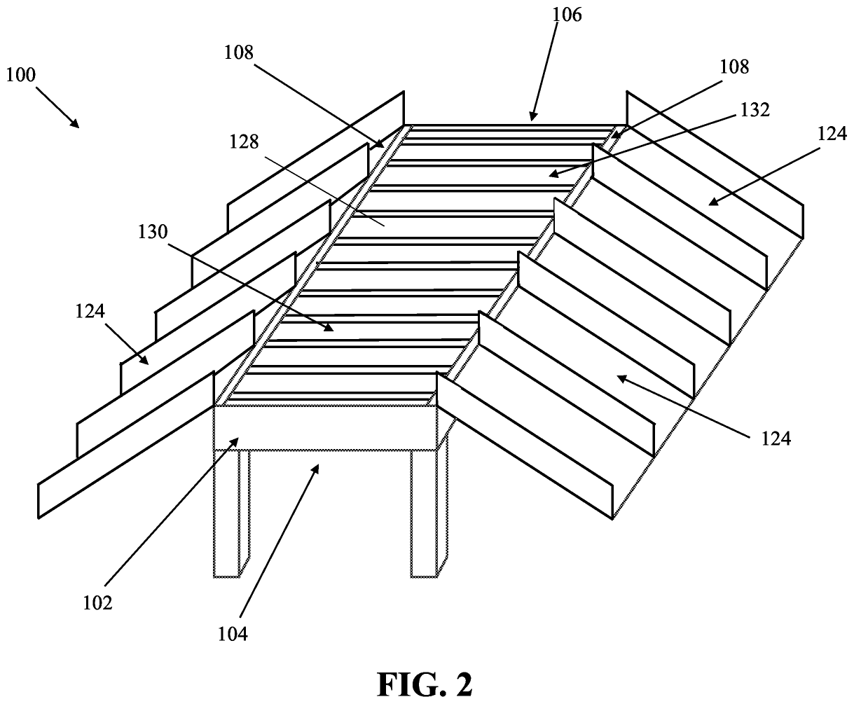

As shown in FIG. 2, the sorter system 100 may include a plurality of chutes 124 extending from the sides of the conveying surface 128 from the proximal end 104 of the sorter system 100 to the distal end 106. The chutes 124 are configured to receive objects or packages which are moved off the conveying surface 128, such as by actuation of one or more carriages 130, and which may direct the packages to a receiving location. For example, the chutes 124 may be angled with a bin or receptacle at the end of the chute 124 such that the package may move down or along the chute 124 due to gravity and be received or collected in the receptacle. Each chute 124 may correspond to a particular characteristic of the package such that packages may be grouped and/or sorted by the package characteristics. For example, each chute 124 may correspond to a particular shipping location, such as a zip code. While not shown, the sorter system 100 may also include one or more chutes 124 extending from the distal end 106 of the sorter system 100.

In other embodiments, the sorter system 100 may be used without chutes and may be used with a plurality of receptacles, such as containers, bins, or hampers, disposed or otherwise placed along the frame sides 108 and at the distal end 106 of the sorter system 100. The receptacles may be disposed such that the receptacles may receive packages which are moved off the conveying surface 128, such as by actuation of one or more carriages 130. In some embodiments, the receptacles may be actuated to move up and down relative to the conveying surface 128 to better receive objects from the conveying surface 128.

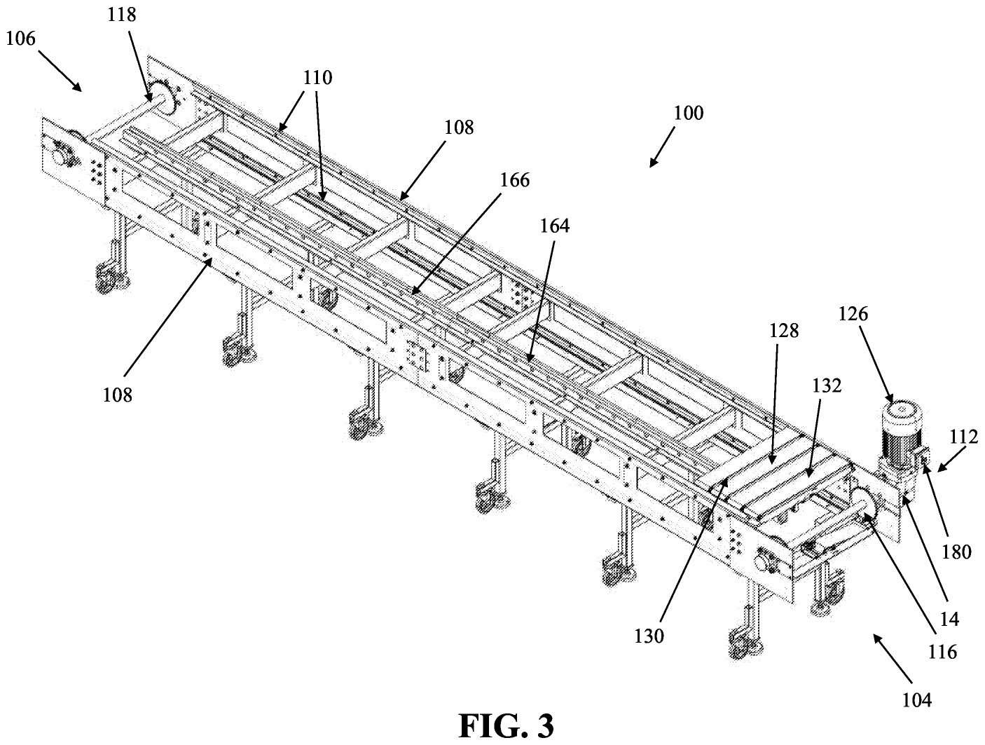

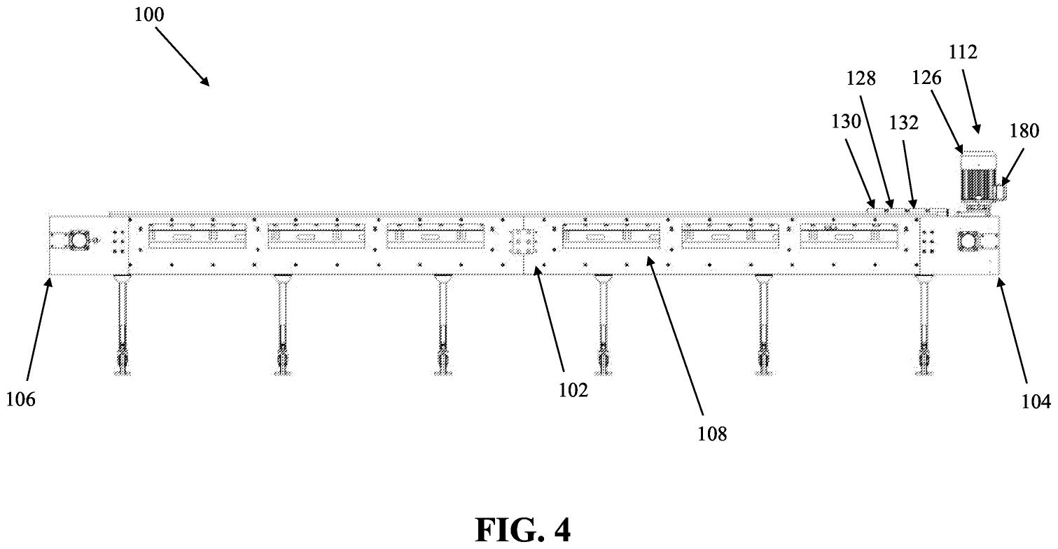

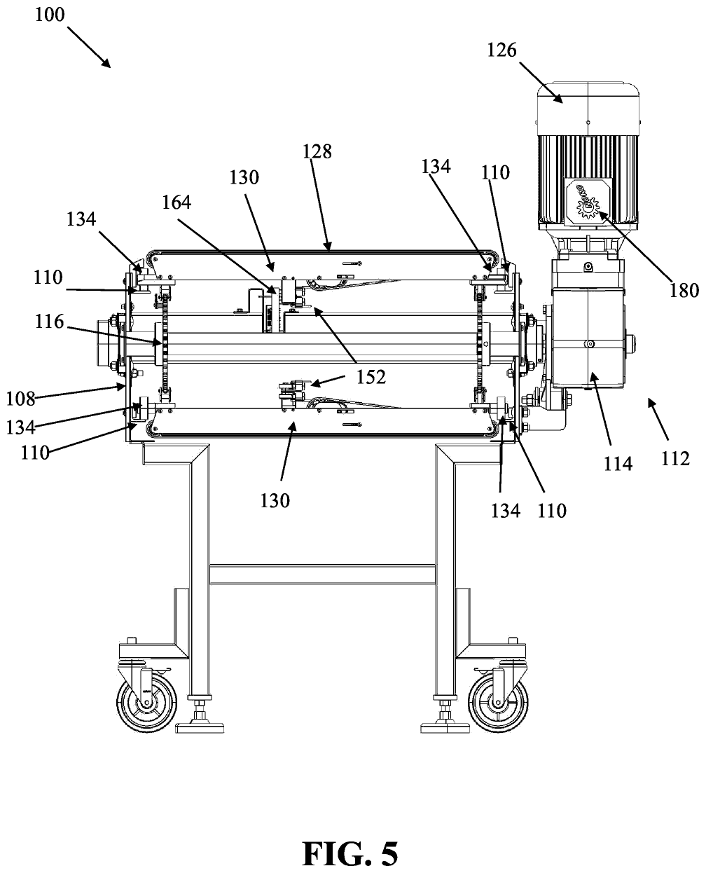

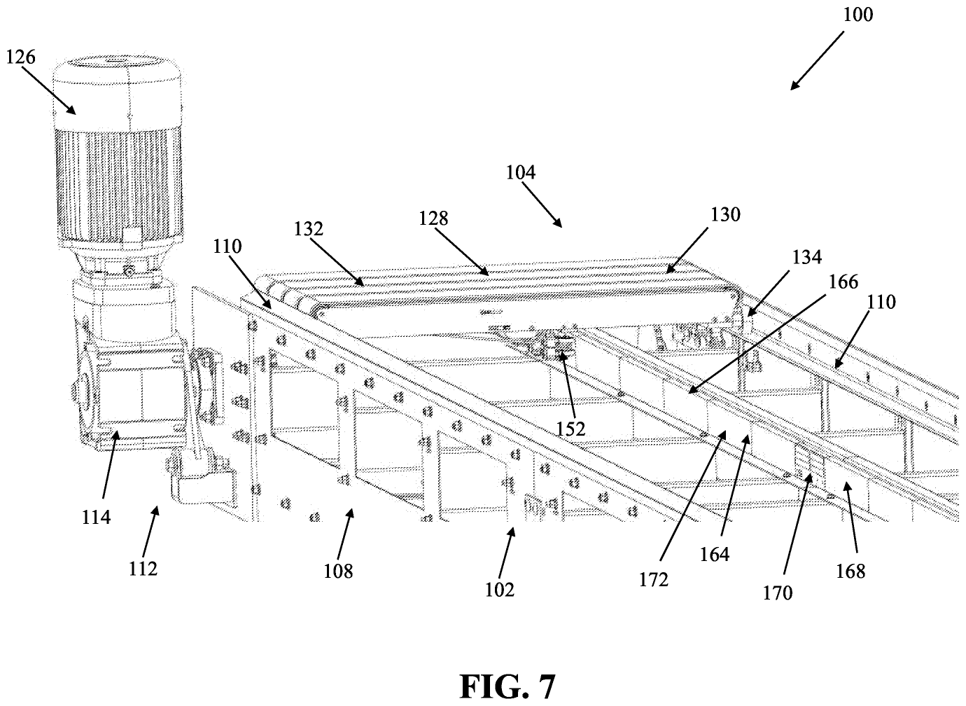

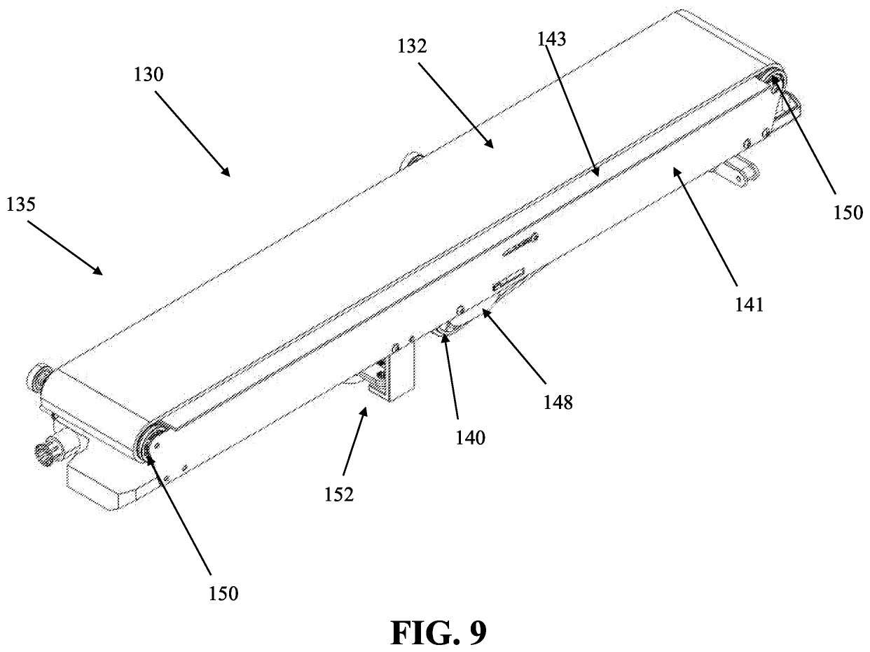

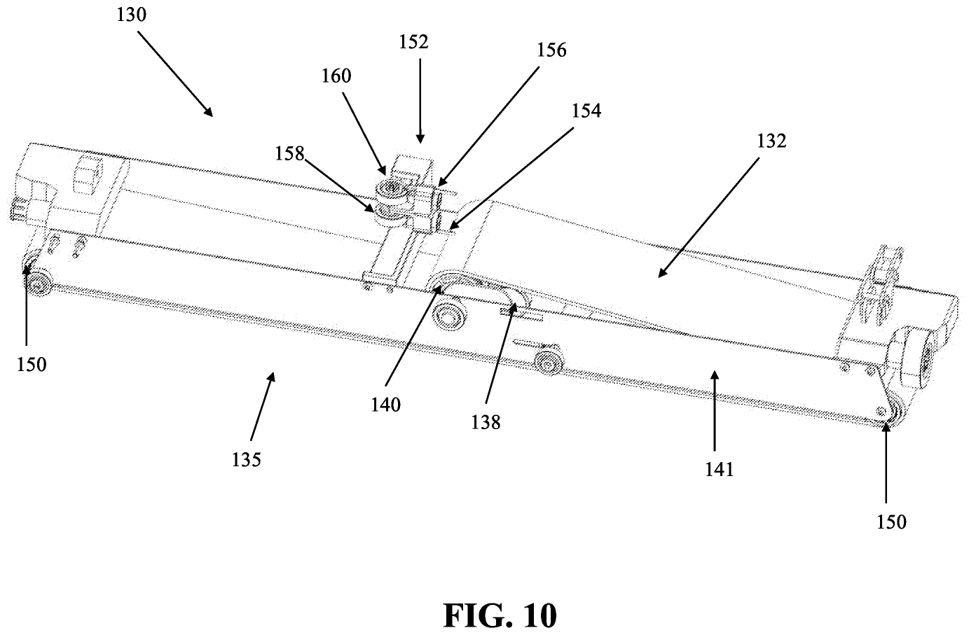

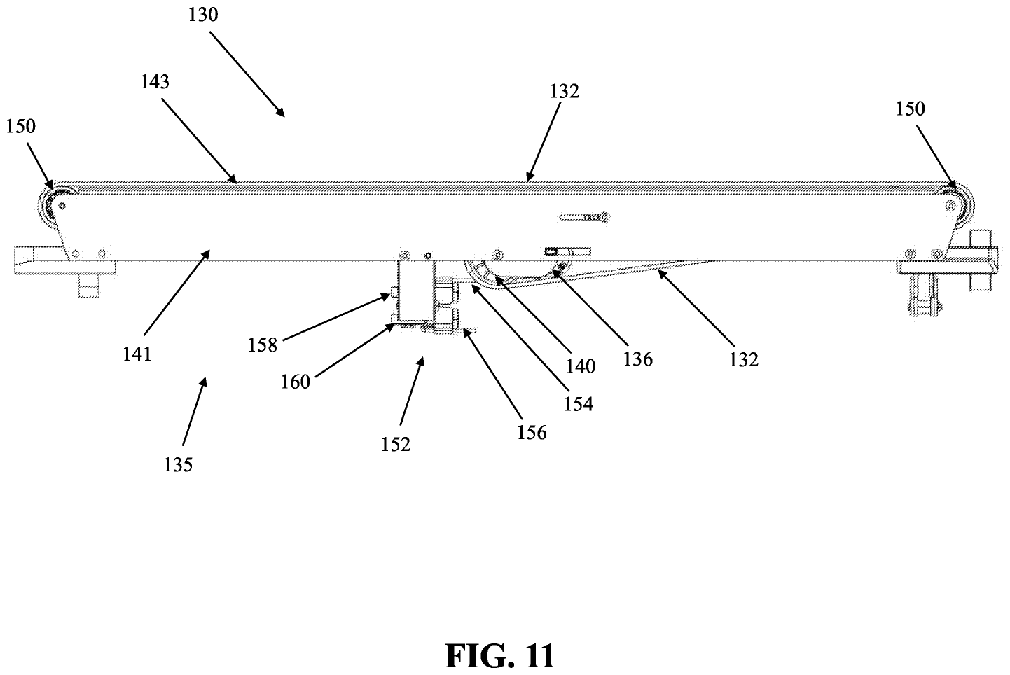

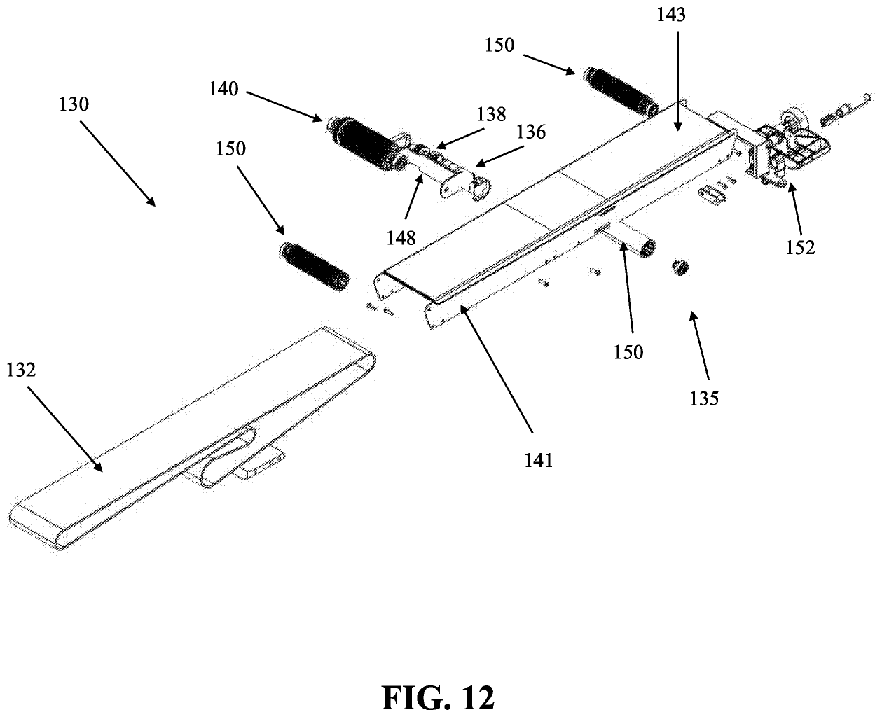

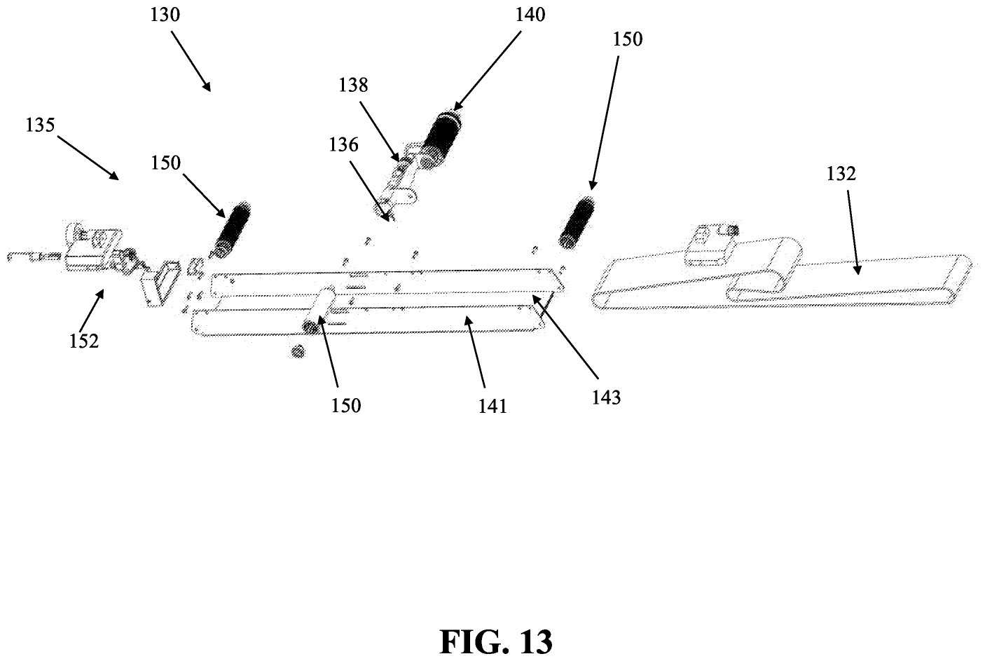

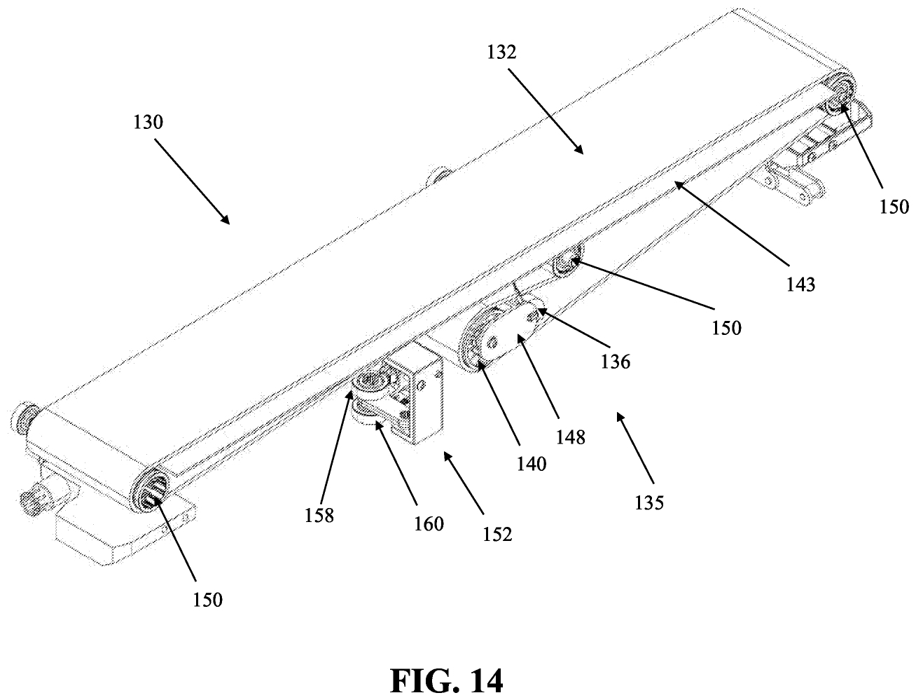

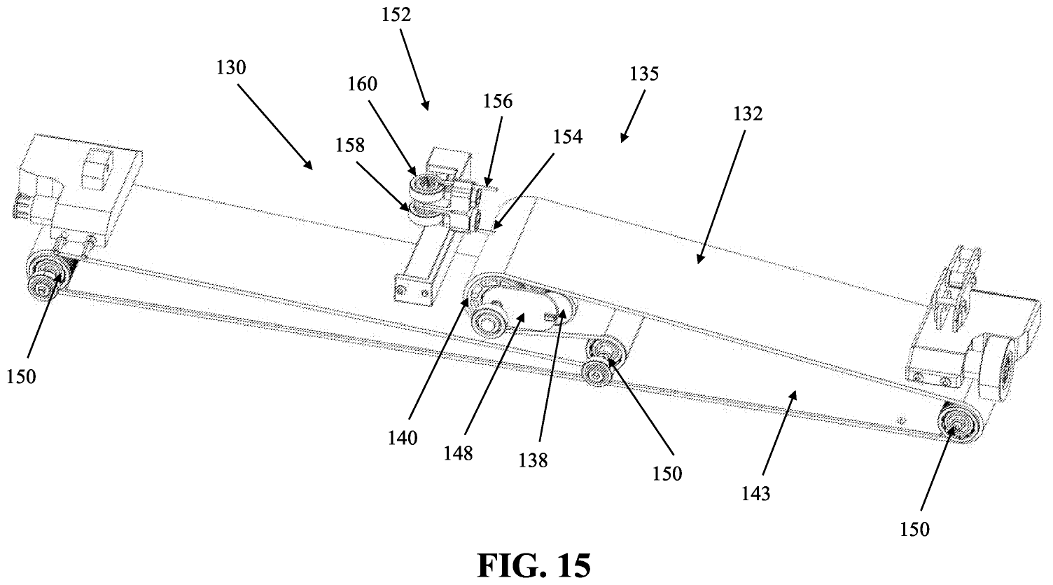

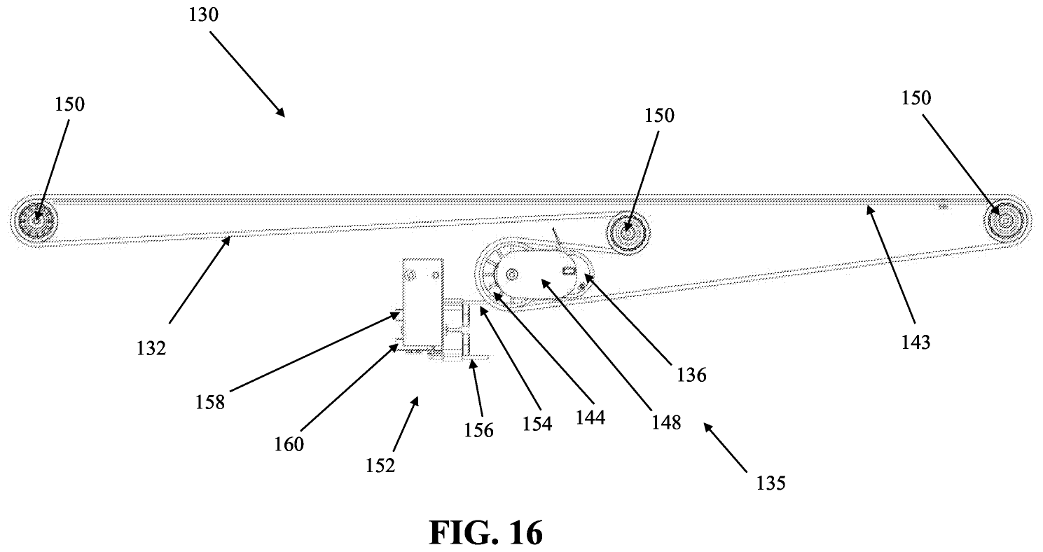

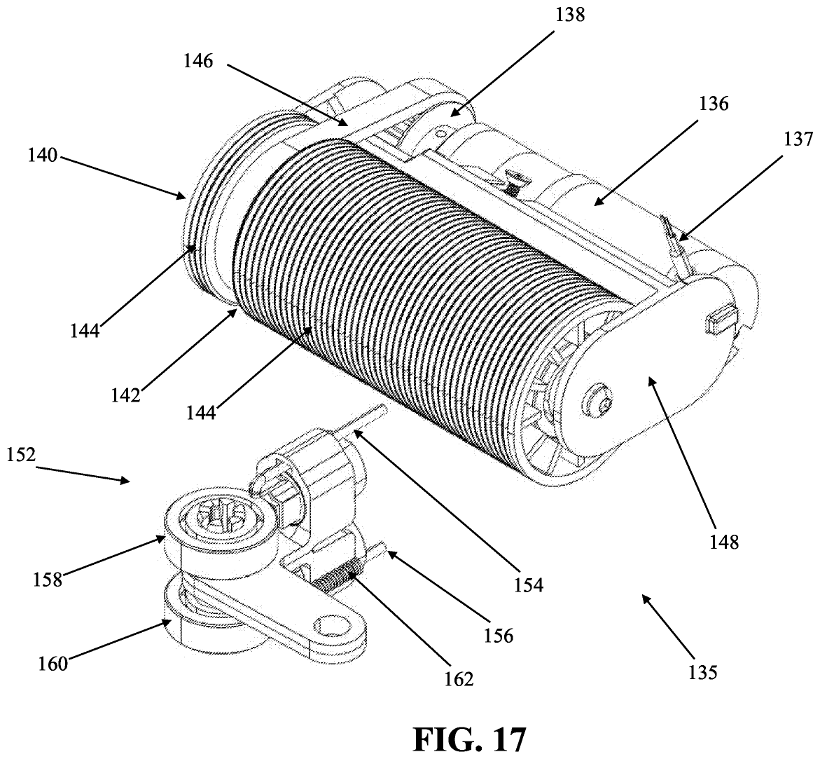

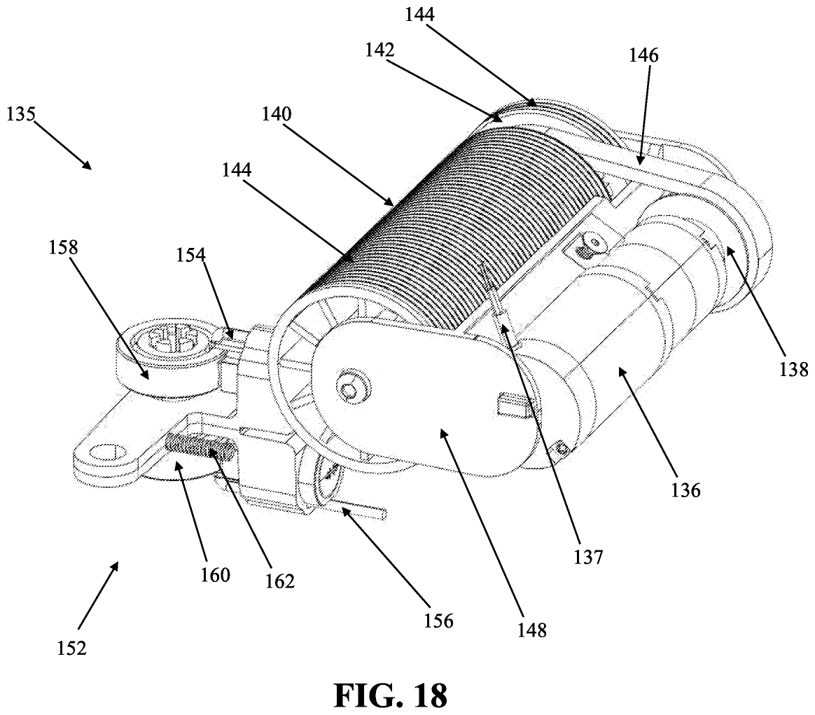

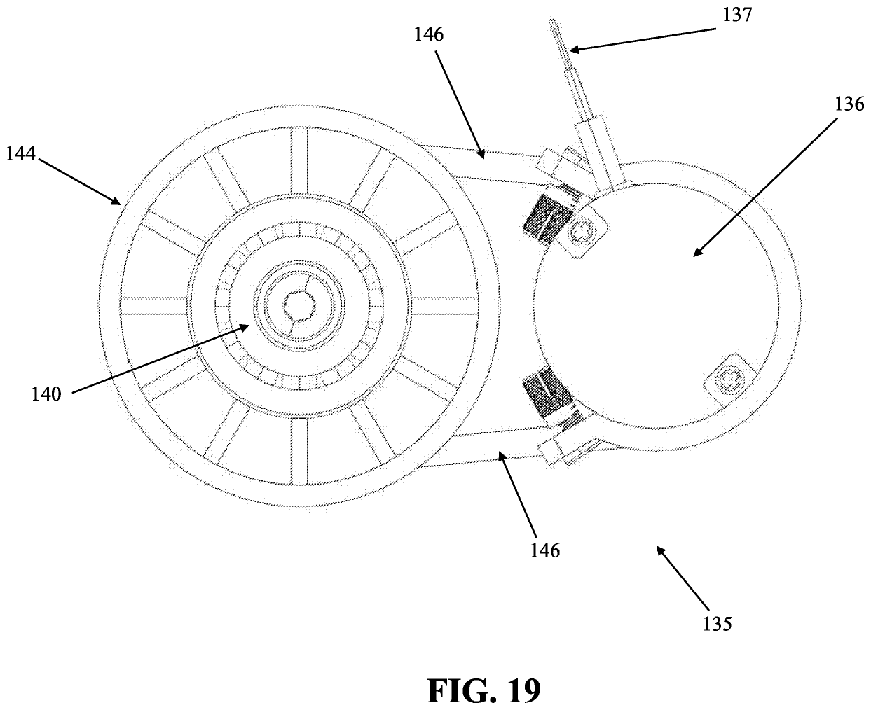

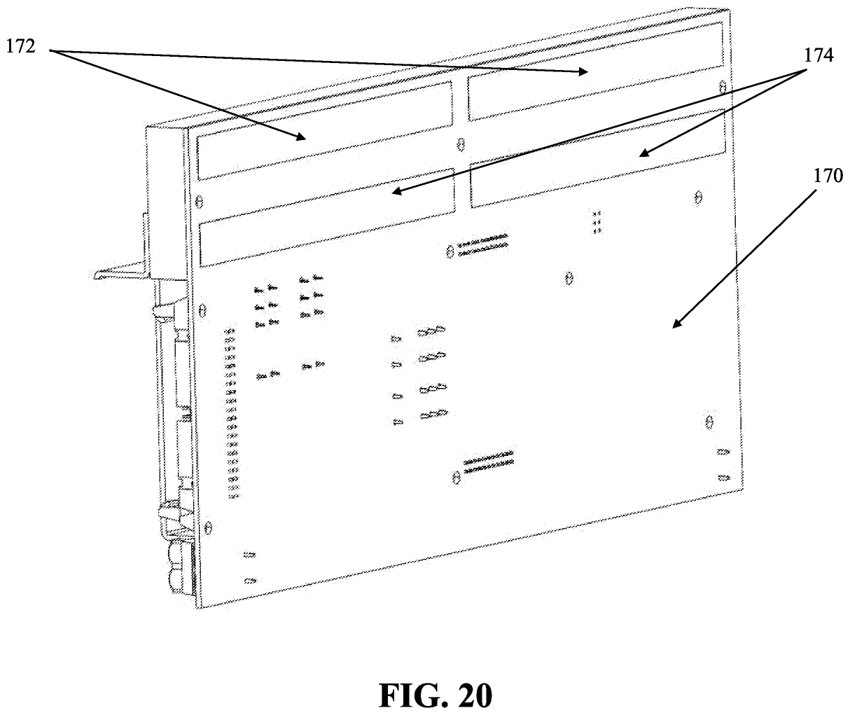

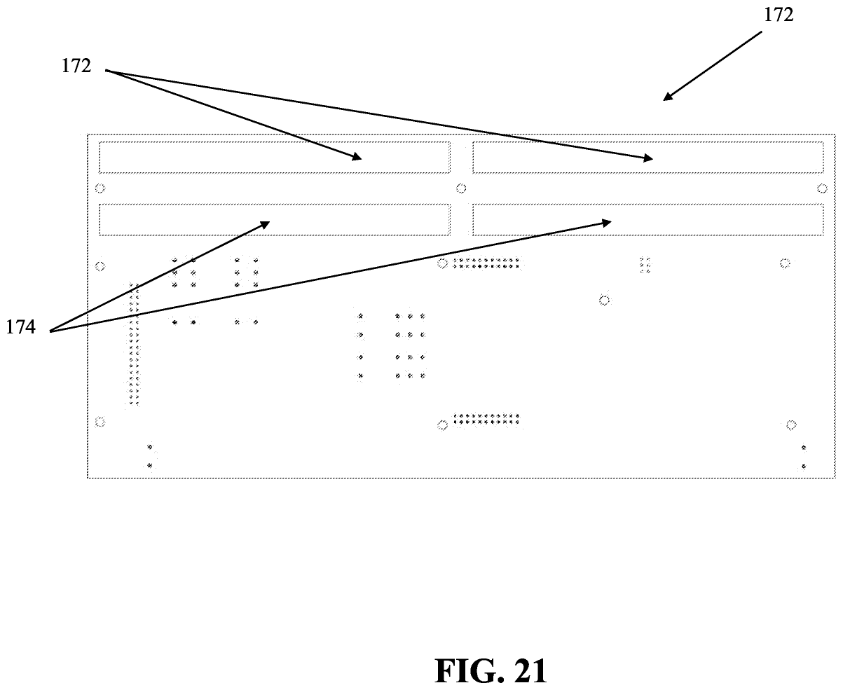

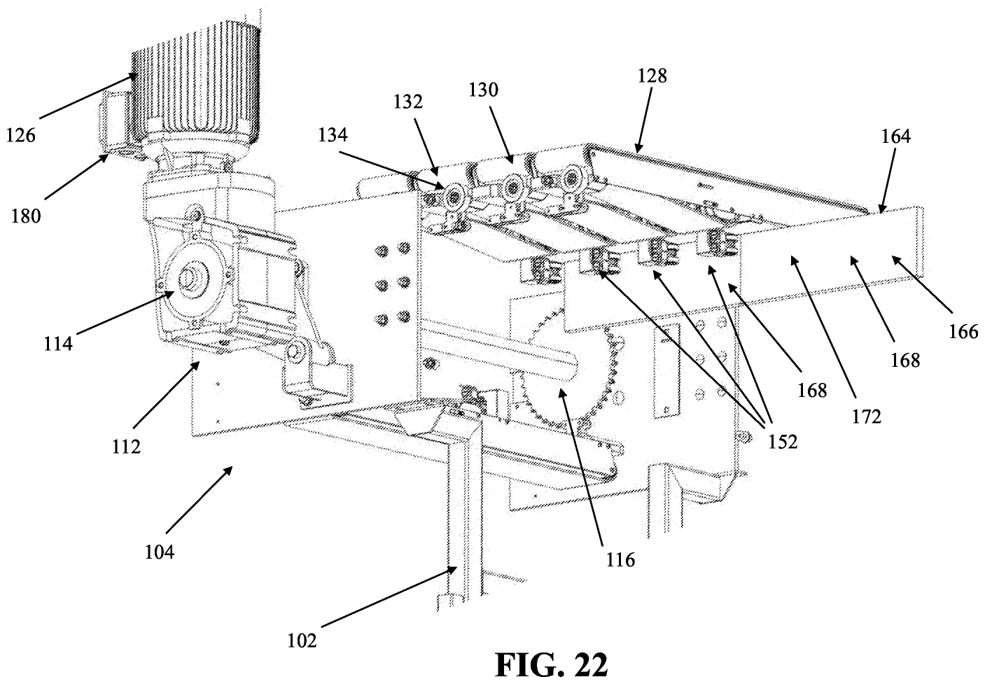

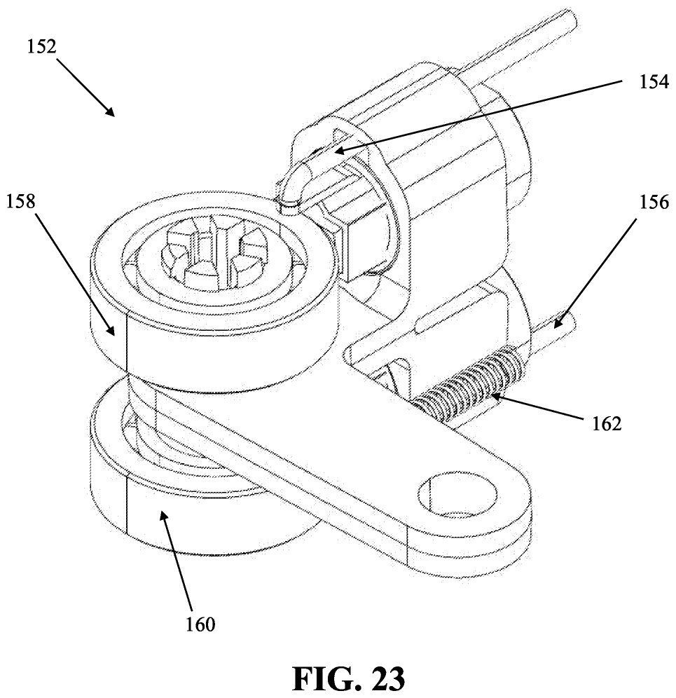

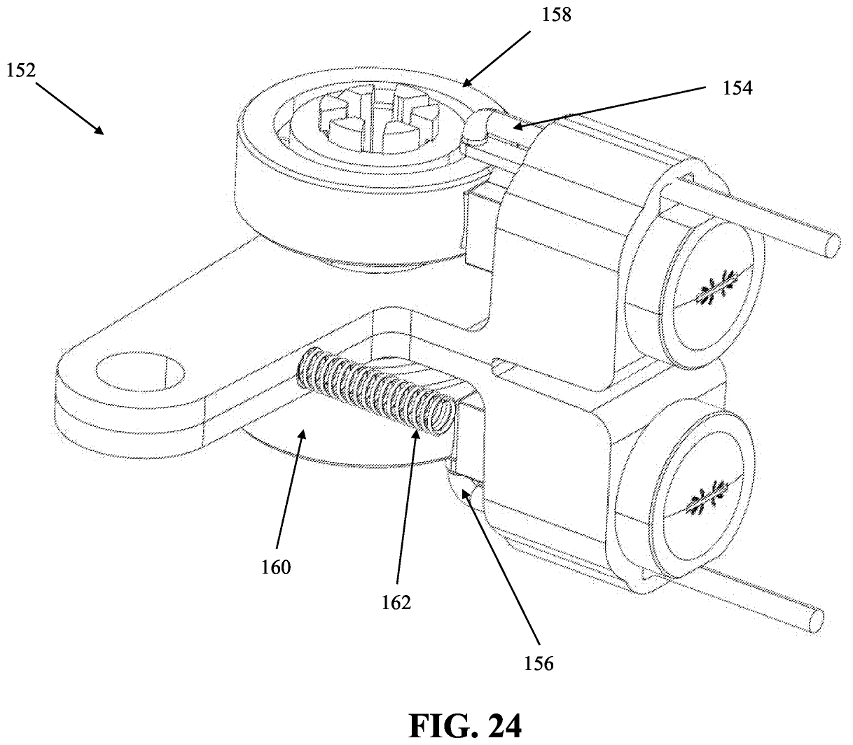

Referring now to FIGS. 3-24, a partial sorter system 100 is shown depicting the components that the sorter system 100 schematically illustrated in FIGS. 1-2 can take. As shown in FIGS. 3-8, the frame 102 of the sorter system 100 may include one or more tracks 110 between the frame sides 108 configured to guide or otherwise allow the carriages 130 to move in a substantially continuous loop within the frame 102 such that the top surfaces of the carriages 130 travelling at the first height may at least partially define the conveying surface 128. In the illustrated embodiment, the tracks are L- or C-shaped such that wheels of the carriages 130 may be retained within the tracks 110. In the illustrated embodiment, the tracks 110 are disposed at a top and at a bottom of the frame 102. However, it will be understood that the tracks 110 may be connected in a loop configuration such that the carriages 130 moving along the top track 110 from the proximal end 104 to the distal end 106 may move down to the bottom track 110, move from the distal end 106 to the proximal end 104, and move back up to the top track 110 near the proximal end 104. Additionally, the illustrated tracks 110 are disposed along an inside surface of the frame sides 108. However, it will be understood that the tracks 110 may be disposed in any suitable configuration or position. For example, the carriages 130 may move around a single looped track 110 disposed substantially in the center of the frame 102.

The carriages 130 may be disposed on the tracks 110 such that the carriages 130 form a continuous loop around the tracks 110. The carriages 130 may be individually placed on the tracks 110 such that the carriages 130 form a continuous loop or the carriages 130 may be pivotably connected to each other, such as via pivotable connectors, fasteners, or linkages, such that the carriages 130 may move in a collective loop around the tracks 110.

As shown in FIGS. 3-7, the sorter system 100 may also include a carriage drive system 112 configured to drive or otherwise move the carriages 130 on the tracks 110. The carriage drive system 112 may include a motor 114 coupled to a drive shaft 116 within the frame 102. The motor 114 may be coupled to a power source 126 to provide power to the motor 114 to cause the drive shaft 116 to rotate. The drive shaft 116 may be disposed near the proximal end 104 of the sorter system 100 and be connected to a follower shaft 118 near the distal end 106 of the conveyor system. The drive and follower shafts 116, 118 may include a rod or shaft rotatably secured in the frame 102, such as within the frame sides 108, and a wheel or gear. The gears of the drive and follower shafts 116, 118 may be aligned and connected or otherwise coupled with one or more coupling device such as a drive belt, a linked chain, or the like. The coupling device may be coupled to, in abutment with, or otherwise connected to the carriages 130 on the tracks 110 such that movement or rotation of the coupling device moves or rotates the carriages 130 along the tracks 110. Rotation of the drive shaft 116 may rotate the coupling device, thereby rotating the follower shaft 118 and the carriages 130 along the tracks 110. The power source 126 may provide power to the motor 114 which causes the drive shaft 116 to rotate which rotates the coupling device, thereby rotating the follower shaft 118 and moving or rotating the carriages 130 along the tracks 110.

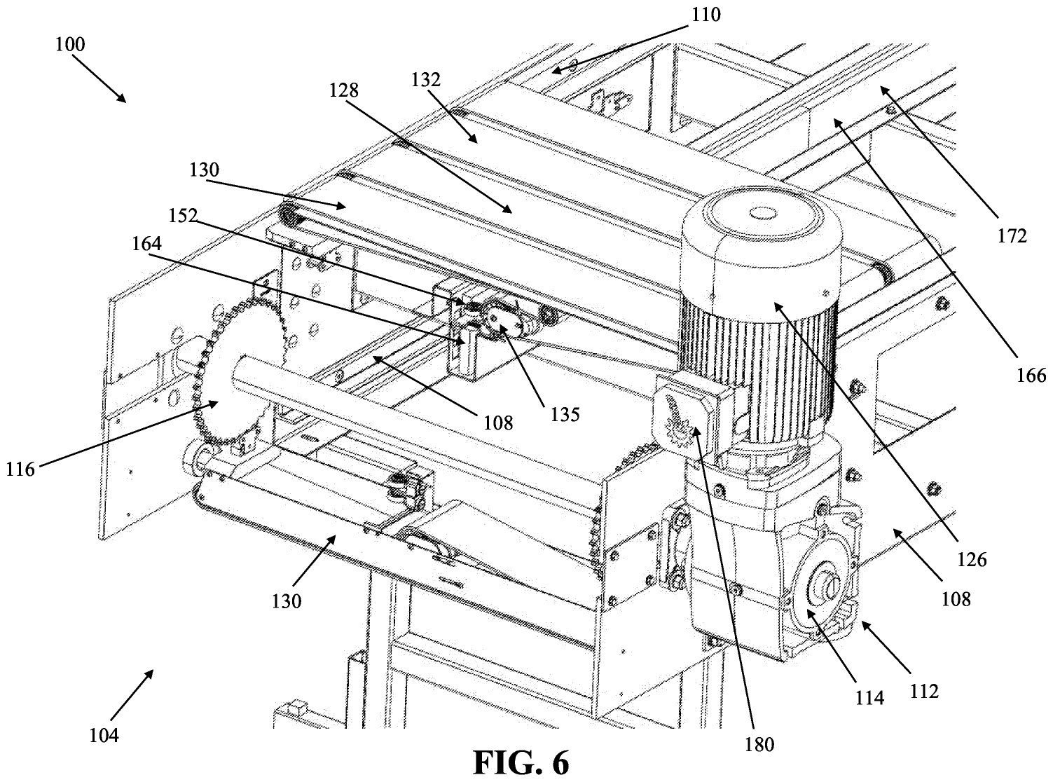

As shown in FIGS. 6-19, the carriages 130 include belts 132 and are configured to move along the conveying surface 128 from the proximal end 104 to the distal end 106 of the sorter system 100 and to move packages disposed on the conveying surface 128 to the sides and/or end of the sorter system 100, such as into chutes 124 or receptacles. The carriages 130 may include one or more carriage wheels 134 on opposite sides of the carriage 130 which may be disposed on and/or in the tracks 110 of the frame 102 such that the carriages 130 may move along the tracks 110. While the carriages 130 are described as having wheels 134 fitting in and/or on tracks 110 in the frame 102, it will be understood that the carriages 130 may be moved around the sorter system 100 by other means. For example, the carriages 130 may be coupled to the sorter system 100 via magnets and driven around the sorter system 100 in a loop configuration via magnetic induction.

Each carriage 130 includes a belt drive system 135 with a belt drive motor 136 connected to a belt drive shaft 138 configured to rotate the belt 132 within and/or around the carriage 130, such as in directions perpendicular to the traveling direction of the carriage 130 along the conveying surface 128. The belt drive motor 136 may be coupled to a power source, such as the power source 126 of the carriage drive system 112, either directly or indirectly, such that the belt drive motor 136 causes the belt drive shaft 138 to rotate. The belt drive motor 136 may be configured to rotate the belt drive shaft 138 in either a first direction or a second direction (e.g., clockwise or counterclockwise), such as based upon the power (voltage, current, polarity, etc.) received by the belt drive motor 136. For example, the belt drive motor 136 may rotate the belt drive shaft 138 in the first direction (e.g., clockwise) when a first power with a first polarity is received and rotate the belt drive shaft 138 in the second direction (e.g., counterclockwise) when a second power with a second polarity opposite the first polarity is received.

The belt drive system 135 may also include a belt drive roller 140 disposed adjacent to and in parallel with the belt drive shaft 138 and coupled or otherwise connected to the belt drive shaft 138 with a drive connector 146 configured to rotate the belt drive roller 140 with the belt drive shaft 138. The drive connector 146 may have a size, shape, and configuration suitable to rotate the belt drive roller 140 in the same direction (e.g., clockwise or counterclockwise) as the belt drive shaft 138. For example, the drive connector 146 may be a v-belt type connector, may comprise polyurethane and/or rubber, may be pitched, and/or may comprise a plurality of shaped or patterned teeth or ribs which may correspond to notches or receiving portions of the drive belt shaft 138 and the belt drive roller 140. The belt drive shaft 138 and the belt drive roller 140 may be rotatingly connected to a belt drive frame 148 which secures the belt drive motor 136, belt drive shaft 138, and belt drive roller 140 in an aligned position to each other. For example, the belt drive motor 136 may be substantially cylindrical and in line with the belt drive shaft 138 such that the belt drive motor 136 and belt drive shaft 138 are on one side of the belt drive frame 148 and the belt drive roller 140 is on the other side of the belt drive frame 148 with the belt drive roller 140 having a length along the rotational axis which is substantially the combined length of the belt drive motor 136 and the belt drive shaft 138.

The drive connector 146 may be at least partially looped around a wheel or roller of the belt drive shaft 138 and within a belt receiving channel 142 extending around a circumference of the belt drive roller 140 such that the drive connector 146 is securely retained on the belt drive shaft 138 and the belt drive roller 140. The belt receiving channel 142 may have a diameter substantially equal to the diameter of the wheel of the belt drive shaft 138 which is less than a diameter of an outer circumference 144 of the belt drive roller 140 which extends along the rotational axis of the belt drive roller 140 in both directions from the belt receiving channel 142. The outer circumference 144 of the belt drive roller 140 may have a diameter which is large enough to keep the drive connector 146 in the belt receiving channel 142 and be configured to drive the rotation of the belt 132 of the carriage 130. The outer circumference 144 of the belt drive roller 140 may include a plurality of ridges or ribs configured to increase friction with the belt 132 and drive the rotation of the belt 132, as described below.

The belt drive system 135 may also include one or more belt support rollers 150 configured to at least partially support the carriage belt 132 such that a portion of the carriage belt 132 is horizontally disposed near the top of the frame 102 and defines a part of the conveying surface 128 (when the carriage 130 is on an upper portion of the tracks 110) and to permit the carriage belt 132 to rotate. The belt drive system 135 may include two belt support rollers 150 disposed at the sides of the carriage 130 at an upper position such that the two belt support rollers 150 are near the top of the frame sides 108 when the carriage 130 is disposed on the upper portion of the tracks 110. The belt 132 may disposed across the tops of the belt support rollers 150 and at least partially around the outside of each of the belt support rollers 150. The portion of the belt 132 extending between the two upper belt support rollers 150 may be substantially horizontal and define a part of the conveying surface 128 when the carriage 130 is disposed in the upper portion of the tracks 110.

The belt drive system 135 may also include a third belt support roller 150 configured to direct the belt 132 from the belt drive roller 140 to the upper belt support roller 150 disposed on the same side of the carriage 130 as the belt drive roller 140 such that the belt 132 is substantially horizontal and taught between the upper belt supper rollers 150. The third belt support roller 150 may be disposed at a height between the belt drive roller 140 and the upper belt support rollers 150.

The belt support rollers 150 may be substantially cylindrical and have diameters substantially equivalent to the wheel of the belt drive shaft 138 and the belt receiving channel 142 of the belt drive roller 140. The outer circumference of each of the belt support rollers 150 may have a plurality of ribs or ridges configured to increase friction with the belt 132 and such that the belt support rollers 150 may rotate with the belt 132. Further, each of the belt support rollers may be rotatingly coupled or fastened to a carriage frame 141 which substantially surrounds a bottom and sides of the carriage 130. For example, a rod or shaft may extend through the carriage frame 141 and through the belt support rollers 150 rotational axis of each of the belt support rollers 150, and the rod or shaft may be secure on the opposite sides of the carriage frame 141 by fasteners or caps. Each carriage 130 may also include a belt support frame 143 disposed between the upper two belt support rollers 150 configured to support the portion of the belt 132 defining the conveying surface 128. For example, the belt support frame 143 may maintain the belt 132 in a horizontal position when an object is disposed thereon and may be secured or otherwise connected to the carriage frame 141.

The belt drive system 135 may be positioned and/or configured such that the width of the carriage 130 and/or the carriage belt 132 in the direction extending in the travel direction of the carriage 130 may be reduced. For example, the width of the carriage belt 132 may be substantially equivalent to the length of the belt drive roller 140, the belt support rollers 150, and/or the combination of the belt drive motor 136 and belt drive shaft 138 and the carriage 130 may have a width substantially equal to or slightly larger than the width of the carriage belt 132. For example, the carriage belt 132 may have a width between about 3 inches and about 10 inches, such as between about 4 inches and about 7 inches, such as about 5 inches, and the carriage 130 may have a width between about 4 inches and about 12 inches, such as between about 5 inches and about 9 inches, such as about 6 inches.

In some embodiments, the belt drive motor 136, the belt drive shaft 138, belt drive roller 140, drive connector 146, and belt support rollers 150 are disposed inboard within the carriage 130, such as within the carriage frame 141, such that the belts 132 have widths substantially equal to the width of the carriages 130. As such, the carriages 130 may be disposed and aligned on the tracks 110 of the sorter system 100 such that there are minimal gaps between the belts 132.

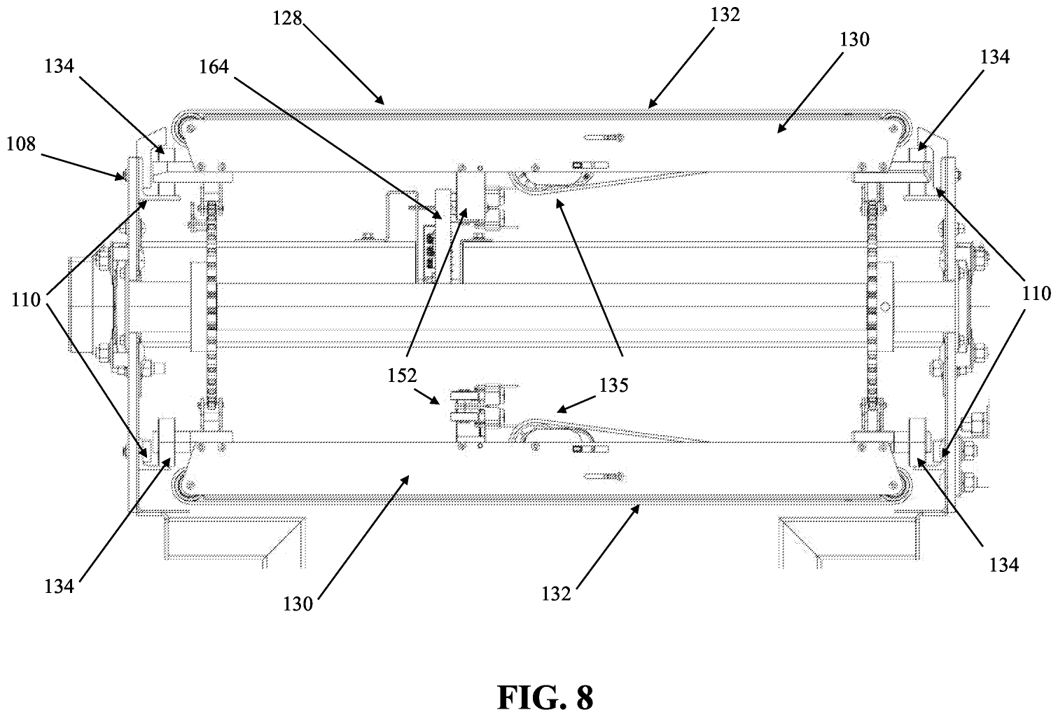

As shown in FIGS. 8-18 and 22-24, each carriage 130 may also include a belt power system 152 configured to deliver power or electricity to the belt drive motor 136 to rotate the belt drive shaft 138 thereby rotating the belt 132 in either the first or second direction. The belt power system 152 may include a first power takeup 154 configured to receive and direct a first power (voltage, current, polarity, etc.) to the belt drive motor 136 and a second power takeup 156 configured to receive and direct a second power (voltage, current, polarity, etc.) to the belt drive motor 136. The first and second power takeups 154, 156 may receive power directly or indirectly from the power source 126. The first and second power takeups 154, 156 may be electrically connected to a motor power input 137 which may receive power from the first and second power takeups 154, 156 and thereby actuate the belt drive motor 136 to rotate the belt drive shaft 138 in either the first or second direction based upon the power received, such as based upon the polarity of the power received. The first and second power takeups 154, 156 may be electrically coupled to the motor power input 137 via electrically conductive wires, fasteners, or the like and the belt drive motor 136 may be a brush DC motor configured to actuate the belt drive shaft 138 in either the first or second direction based upon the received power level.

In some embodiments, the belt power system 152 also includes a first power receiver 158 electrically coupled to the first power takeup 154 and a second power receiver 160 electrically coupled to the second power takeup 156. The first and second power receivers 158, 160 may be electrically conductive bearings or rollers which may roll along and conduct power from a sorter power system, as described below. The first power receiver 158 may be configured to conduct a first power from the sorter power system and the second power receiver 160 may be configured to conduct a second power from the sorter power system. The first and second power takeups 154, 156 may include conductive brushes configured to receive the first and second power levels from the first and second power receivers 158, 160, respectively, as described below. For example, the first and second power receivers 158, 160 may be stainless steel roller bearings and the first and second power takeups 154, 156 may be or include graphite brushes configured to receive power from the first and second power receivers 158, 160, respectively, and conduct the received power to the motor power input 137. In some embodiments, the belt power system 152 may not include first and second power receivers 158, 160 and the first and second power takeups 154, 154 may be positioned and configured to pass along in contact with the sorter power system and conduct power directly from the sorter power system to the belt drive motor 136.

Each belt power system 152 may also include a biasing element 162, such as a coil spring, leaf spring, or the like, configured to bias the first and second power receivers 158, 160 against sorter power systems, such as to cause the first and second power receivers 158, 160 to continuously roll along the sorter power system. Additionally, the first and second power takeups 154, 158 and the first and second power receivers 158, 160 may be movably connected to an L-shaped frame which may permit the first and second power receivers 158, 160 to maintain connection with the sorter power system while providing power to the belt drive motor 136.

In some embodiments, the belt drive system 135 and the belt power system 152 may be configured and disposed within each carriage 130 such that the belts 132 have widths substantially equal to the widths of the carriages 130 and the belts 132 substantially cover the top surface of the carriage 130 (when disposed in the upper portion of the tracks 110). For example, the belt power system 152 may be disposed substantially beneath the belt drive system 135 and laterally between the upper belt support rollers 150, such that the belt power systems 152 may receive power and that the belts 132 may substantially define the conveying surface 128 with minimal or no gaps between the carriages 130.

As shown in FIGS. 3, 5-8, 20-21, and 22, the sorter system 100 may include a sorter power system 164 configured to selectively supply power to one or more carriages 130 disposed along an upper portion of the tracks 110, thereby actuating the belts 132 of the respective carriages 130 defining the conveying surface 128 in either the first or second direction. The sorter power system 164 may include a conductive track 166 extending from the proximal end 104 to the distal end 106 of the frame 102 and disposed below the conveying surface 128. The conductive track 166 may be configured and disposed within the frame 102 such that the first and second power receivers 158, 160 of the carriages 130 disposed in the upper portion of the tracks 110 may be at least partially received on or in and in contact with the conductive track 166, such as via continuous rolling contact with the conductive track 166. The conductive track 166 may include a plurality of independently powered or energized power panels or sections 168 disposed along the length of the conductive track 166. Each of the power sections 168 may be independently coupled to the power source 126, such as via electrically conductive wires, such that the power source 126 may provide power, to one or more power sections 168 such that first and/or second power may be supplied one or more carriages 130. The power sections 168 may have a length substantially equal to the width of one of the carriages 130. For example, each of the power sections 168 may have a length between about 4 inches and about 12 inches, such as between about 5 inches and about 9 inches, such as about 6 inches.

Each of the power sections 168 may include a circuit board 170 disposed across the length of the power section 168 and configured to receive power directly or indirectly from the power source 126 and transfer or conduct power to one of the carriages 130, such as to the first and/or second power receivers 158, 160 of the carriage. The circuit boards 170 may include at least one first power strip 172 configured to conduct or transfer power, such as a first power with a first polarity, to the first power receivers 158 and at least one second power strip 174 configured to conduct or transfer power, such as a second power with a second polarity opposite the first polarity, to the second power receivers 160. The first and second power strips 172, 174 may be disposed across the side of the circuit board 170 such that the first power strip 172 may provide power to the first power receiver 158 and the second power strip 174 may provide power to the second power receiver 160 as the carriage 130 passes along the power section 168. In some embodiments, the first and second power strips 172, 174 comprise copper and are embedded in the circuit boards 170. In the illustrated embodiment, the circuit board 170 includes two first power strips 172 and two second power strips 174 disposed across the surface of the circuit board 170. However, it will be understood that the circuit board 170 may have other suitable configurations. For example, the circuit board 170 may have one first power strip 172 and one second power strip 174 each disposed substantially across the circuit board 170 or the circuit board 170 may have three or more first and/or second power strips 172, 174.

In some embodiments, the circuit boards 170 are printed circuit boards configured to direct received power to the first and second power strips 172, 174 such that the first power conducted by the first power strip 172 has a different polarity from the second level conducted by the second power strip 174 and/or such that the first and second power strips 172, 174 may collectively provide first power with a first polarity to the carriage 130 in one configuration and second power with a second polarity opposite the first polarity to the carriage 130 in another configuration. The circuit board 170 may include a solid state control or relay configured to switch the polarity of the first and second power strips 172, 174 such that in one configuration the first and/or second power strips 172, 174 conduct a first power with a first polarity to the carriage 130 and, in a second configuration, conduct a second power with a second polarity opposite the first polarity to the carriage 130, thereby actuating the belt 132 of the carriage 130 in either the first direction (first polarity) or the second direction (second polarity).

The conductive track 166, power sections 168, and/or circuit boards 170 may be configured such that the first power receiver 158 may roll along one of the first power strips 172 and the second power receiver 160 may roll along one of the second power strips 174 when the carriage 130 moves along the upper portion of the tracks 110 past the respective power sections 168. The biasing element 162 may be configured to bias the first power receiver 158 toward the first power strip 172 and the second power receiver 160 toward the second power strip 174 such that the first and second power receivers 158, 160 continuously roll along the first and second power strips 172, 174, respectively. In some embodiments, each power section 168 may also include a cover 176 disposed over the circuit board 170 configured to conduct power from the first power strip 172 to the first power receivers 158, conduct power from the second power strip 174 to the second power receivers 160, and protect the circuit board 170, first power strip 172, and second power strip 174 from wear or physical forces, such as due to frictional forces caused from the first and second power receivers 158, 160 rolling along the power section 168.

The circuit boards 170 may be electrically connected to the power source 126 via a sorter or belt controller system 180. The belt controller system 180 may generate an output or control signal which causes one or more circuit boards 170 to be selectively powered by the power source 126. The belt controller system 180 may also generate an output or control signal which causes the powered circuit boards 170 to direct power to the first and/or second power strips 172, 174 such that the first and/or second power strips 172, 174 conduct a first power, such as a power with a first polarity, or a second power, such as a power with a second polarity opposite the first polarity. The first and/or second power strips 172, 174 which receive power may conduct power to the carriages 130 thereby causing one or more belts 132 along the conveying surface 128 to rotate or move in the first or second direction (e.g., left or right) based upon the power received and/or whether the carriage 130 received power from the first power strip 172 and/or the second power strip 174. For example, the belt drive system 135 may rotate the belt 132 in the first direction when the belt drive motor 136 receives power with the first polarity and may rotate the belt 132 in the second direction when the belt drive motor 136 receives power with the second polarity. However, it will be understood that the belt drive system 135 may rotate the belt in the first and second directions based upon other factors. For example, the belt drive system 135 may rotate the belt 132 in the first direction when the belt drive motor 136 receives power above a threshold level and may rotate the belt 132 in the second direction when the belt drive motor 136 receives power belove the threshold level. Additionally or alternatively, the belt drive system 135 may rotate the belt 132 at varying speeds based upon the power level received by the belt drive motor 136. In some embodiments, the belt controller system 180 is remote from the carriages 130 and/or the circuit boards 170.

In some embodiments, the belt controller system 180 is connected to each of the circuit boards 170 and configured to control an output of each circuit board 170. The power source 126 may be configured to selectively direct power to one or more circuit boards 170 and the belt controller system 180 may then be configured to generate a control signal causing each circuit board 170 to direct the received power to neither, one, or both power strips 172, 174. The circuit boards 170 may be configured to adjust, apportion, or reverse the polarity of the received power when directing the received power to the first and second power strips 172, 174. For example, the power source 126 may direct a power level to the circuit board 170 and the circuit board 170 may be configured to direct the received power to the first power strip 172 or to direct the received power with a reversed polarity to the second power strip 174 based upon the control signal generated by the belt controller system 180. Alternatively, the circuit board 170 may be configured to apportion and direct the received power to the first and second power strips 172, 174 such that there is a first power differential or a second power differential between the first and second power strips 172, 174 based upon the control signal generated by the belt controller system 180. In some embodiments, the circuit boards 170 are each coupled with the belt controller system 180 via a Modbus or ethernet communication protocol and the circuit boards 170 may direct power to the first or second power strip 172, 174 based upon an output of the belt controller system 180.

In other embodiments, the belt controller system 180 is connected to the power source 126 such that the power source 126 may selectively direct first or second powers, such as a first power with a first polarity and a second power with a second polarity opposite the first polarity, to one or more circuit boards 170. Based on the received power level, the circuit boards 170 may be configured to direct or apportion the received power to the first and/or second power strips 172, 174. For example, the circuit boards 170 may be configured to direct power received with the first polarity to the first power strip 172 and to direct power received with the second polarity to the second power strip 174.

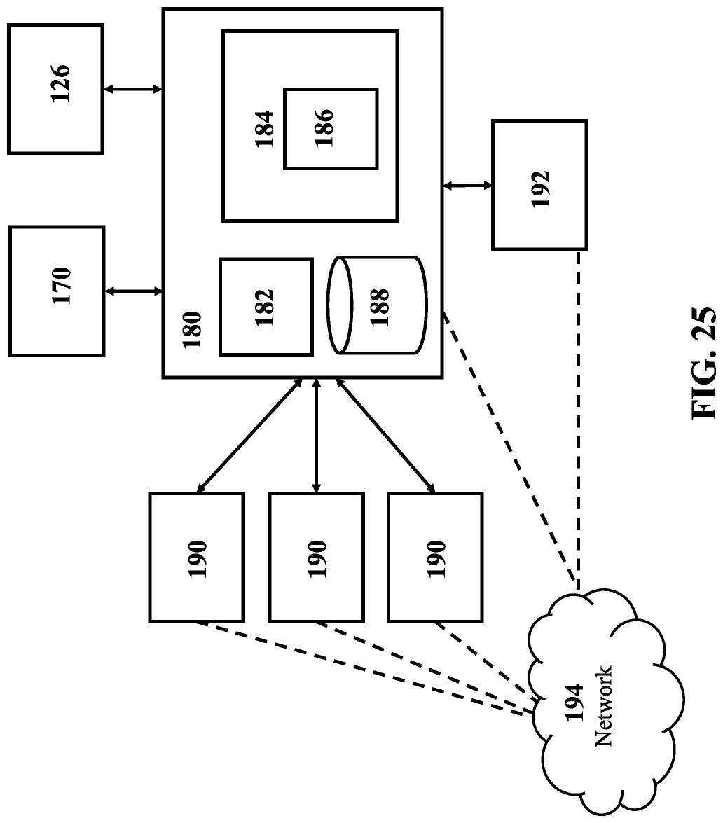

Referring to FIG. 25, the belt controller system 180 may include at least one processor 182 that executes instructions that are stored in a memory 184. Specifically, the memory 184 includes a package conveying system 186 that is configured to identify package(s) on the conveying surface 128, determine the position, location, and orientation of the package(s) on the conveying surface 128, and generate and output to control the belts 132 of one or more carriages 130. For example, the package conveying system 186 may generate an output which causes one or more belts 132 to rotate or move such that one or more packages on the conveying surface 128 are directed or moved into one of the chutes or receptacles. The belt controller system 180 may also include a storage 188 in data communication with the processor 182 and/or memory 184, and which includes information related to the packages, such as the destination chute or receptacle of each of the packages based upon a shipping location of the package. The belt controller system 180 may be configured to output a command to the power source 126 and/or one or more circuit boards 170 based upon the identity and position of the packages on the conveying surface 128 such that the power source 126 energizes one or more first and/or second power strips 172, 174, thereby rotating one or more belts 132 defining the conveying surface 128 in the first or second direction. For example, the belt controller system 180 may output a command to one or more circuit boards 170 causing the circuit boards 170 to energize the first and/or second power strips 172, 174 with a first power with a first polarity to direct the package(s) in the first direction or to energize the first and/or second power strips 172, 174 with a second power with a second polarity opposite the first polarity to direct the package(s) in the second direction.

Additionally, while illustrated as a single system, it is to be understood that the belt controller system 180 may be a distributed system. Thus, for instance, several devices may be in communication by way of a network connection and may collectively perform tasks described as being performed by the belt controller system 180.

The belt controller system 180 can be a central processing unit (CPU), a graphical processing unit (GPU), a field programmable gate array (FPGA), or any suitable combination of such computing devices. Further, the belt controller system 180 may implement a neural network which may be any suitable type of neural network, including a convolutional neural network, a deep neural network, a recurrent neural network, a graph neural network, etc.

The belt controller system 180 can include or be coupled to one or more sensors 190 configured to generate an output indicative of the identities, locations, positions, and/or orientations of packages disposed on the conveying surface 128 of the sorter system 100. The sensors 190 may be configured to read or otherwise sense identifying information regarding the packages and/or configured to sense or determine the position, location, and/or orientation of the packages disposed along the conveying surface 128. One or more of the sensors 190 may be a barcode reader, a QR reader, a text or label reader, or the like configured to sense or read a label or tag disposed on or in the packages on the conveying surface 128 and generate an output indicative of the of the identifying information (e.g., the contents of the label or tag). In some embodiments, the sorter system 100 may include one or more sensors 190, such as a camera, at the proximal end 104 of the sorter system 100 configured to scan labels of each package disposed on the sorter system 100. One or more sensors 190 may be a radar sensor, a camera, or similar positional sensor configured to generate an output indicative of the location, position, and orientation of one or more packages on the conveying surface 128. For example, one or more sensors 190 may be a camera disposed around or above the conveying surface 128 configured to capture images of at least a portion the conveying surface 128 and generate outputs indicative of the contents of the conveying surface 128. The sensors 190 may be positioned or otherwise positioned to substantially cover and/or capture the entirety of the conveying surface 128. In the illustrated embodiment, the belt controller system 180 is coupled to three sensors 190. However, it will be understood that the sorter system 100 may include any number of sensors 190 within or otherwise coupled to the belt controller system 180.

The outputs of the sensors 190 may be provided as input to the processor 182 and/or the belt controller system 180. Based upon the outputs of the sensor(s) 190 indicative of the identity, position, location, and/or orientation of the package(s) on the conveying surface 128, the belt controller system 180 may be configured to generate an output to control the operation of the sorter system 100.

The package conveying system 186 of the belt controller system 180 may be configured to generate an output indicative of identifying information of one or more packages on the conveying surface 128 of the sorter system 100 based upon an output of the sensors 190. The package conveying system 186 may receive as input an output of one or more sensors 190 indicative of the contents of a lab or tag related to one or more packages and generate an output indicative of a destination location, such as a destination chute or receptacle, for the package(s). For example, the package conveying system 186 may be configured to receive as input an image or scan of a tag or label of a package (e.g., a QR code, barcode, serial or shipment number, shipping label, etc.) and to process the image or scan, such as via text recognition, to generate a representation of the tag or label of the package(s). The package conveying system 186 may then be configured to determine relevant information regarding the package(s) by comparing the processed image or scan with known information related to packages, such as by cross-referencing a barcode, QR code, etc. with a database contained in the storage 188 linking package tags or labels with destination locations.

Based upon the output of the sensor(s) 190, the package conveying system 186 of the package conveying system 186 may assign a destination tag or label to each of the packages on the conveying surface 128. In one embodiment, the package conveying system 186 may be configured to identity a shipping location, such as a zip code, contained in a label of the package, and determine the destination location of the package based upon the zip code. In another embodiment, the package conveying system 186 may be configured to process information contained in a tag or label of the package(s) and cross-reference the tag or label information with a known database of package information to determine the destination location of the package(s).

The package conveying system 186 of the belt controller system 180 may also be configured to generate an output indicative of the position, location, and/or orientation of one or more packages on the conveying surface 128 of the sorter system 100 based upon an output of the sensors 190. The belt controller system 180 may receive as input an output of one or more sensors 190 indicative of the contents of the conveying surface 128 and the package conveying system 128 may be configured to process the input to determine the position, location, and orientation of one or more packages disposed on the conveying surface 128. For example, the processor 182 and/or the package conveying system 186 may be configured to implement an edge or contour analysis of one or more images captured and output by the sensors 190 to generate an output indicative of the position, location, and/or orientation of the package(s) captured in the image(s). The package conveying system 186 may then be configured to generate an output indicative of the contents of the conveying surface 128, such as including the position, location, and orientation of one or more packages disposed on the conveying surface 128. For example, the package conveying system 186 may generate an output indicative of the location and orientation of the package(s) relative to one or more carriages 130 and/or a corresponding portion of the conveying surface 128 (the package will move along the conveying surface 128 along one or more carriages 130) and generate an output indicative of the position of the package along the sorter system 100 relative to the proximal and distal ends 104, 106. In some embodiments, the package conveying system 186 may also be configured to generate an output indicative of the height and/or size of packages disposed on the conveying surface 128.

While the determination of a destination location of a package has been described as being separate from the determination of the position, orientation, and location of a package, it will be understood the identify and positional information of the package(s) may be determined simultaneously. For example, the package conveying system 186 may be configured to simultaneously assign a destination location to one or more packages and to determine the position, location, and orientation of the package(s) on the conveying surface 128 based upon one or more outputs from the sensors 190, such as a plurality of images.

The package conveying system 186 belt controller system 180 may then be configured to generate an output or control signal to control the operation of the sorter system 100 based upon the destination information and position, location, and orientation of the package(s) disposed on the conveying surface 128. The belt controller system 180 may determine the current position, location, and orientation of a package on the conveying surface 128 and determine or calculate a subsequent or desired position, location, and/or orientation for the package based upon the destination location and current position, location, and orientation. The desired position, location, and/or orientation of the package may be calculated or otherwise determined as the destination chute or receptacle or may be an intermediate position, location, and/or orientation for the package before the package is moved into the destination chute or receptacle. For example, the desired position for the package may be determined or calculated such that the package is flush or aligned with one of the frame sides 108, such that an edge of the package is squared with the frame sides 108, such that the package may be more easily moved by the belts 132 of the carriages 130, such that the package extends across the fewest carriages 130 and/or belts 132, such that a face or edge of the package is aligned with the destination location, to minimize the number of carriages 130 that the package is disposed across, and/or to increase the density of packages along the conveying surface 128.

The package conveying system 186 of the belt controller system 180 may be configured to calculate or determine the movement of the belt(s) 132 of one or more carriages 130 defining the conveying surface 128 to move the package(s) from the current position, location, and orientation to the updated or desired position, location, and orientation. The belt controller system 180 may be configured to calculate the movement of the belts 132 in a manner that reduces the number of belts 132 to be actuated, reduces the time to move or orient the package, affects the least number of other packages disposed on the conveying surface 128, decreases the power consumed by the sorter system 100, and/or increases the efficiency of the sorter system 100.

In some embodiments, the package conveying system 186 of the belt controller system 180 may determine that one or more belts 132 should be actuated to move a package into the desired orientation. For example, a package may be disposed across multiple carriages 130 in an angled or skewed orientation. The belt controller system 180 may determine that the belts 132 of one or more carriages 130 supporting a proximal portion of the package should be actuated in a first direction and/or that the belts 132 of one or more carriages 130 supporting a distal portion of the package should be actuated in a second direction such that the package rotates or otherwise moves on the conveying surface 128 such that the package is disposed across fewer carriages 130 and/or such that more packages may be placed on the conveying surface 128.

The package conveying system 186 belt controller system 180 may also be configured to determine that one or more belts 132 should be actuated to move a package into the destination location (e.g., chute or receptacle) as the package is conveyed past the destination location on the conveying surface 128. In some embodiments, a package may be disposed across multiple carriages 130 and the package conveying system 186 may determine that the belts 132 each of the supporting carriages 130 should be actuated simultaneously in the first or second or direction such that the package is laterally moved from the conveying surface 128 to the chute 124. In other embodiments, the package conveying system 186 may determine that the belts 132 of supporting carriages 130 should be actuated in the first and/or second directions sequentially or at different times such that the movement of the package is more efficient, that the package fits within the chute 124, to prevent other packages from being accidentally moved into the chute 124, and/or the like.

The package conveying system 186 and/or the belt controller system 180 may generate an output or control signal which causes the power source 126 to direct power to one or more power sections 168 and the respective circuit boards 170 to direct power to the first and/or second power strips 172, 172 to selectively actuate the belts 132 of the carriages 130 moving along the conveying surface 128 in the first or second direction, such as to move packages from a current position, location, and orientation to the desired position, location, and orientation. For example, based upon the output of the package conveying system 186 and/or the belt controller system 180, the power source 126 may direct power to the circuit boards 170 of one or more power sections 168 and the belt controller system 180 may generate a control signal for each of the respective circuit boards 170 such that the circuit board 170 directs the received power to the first and/or second power strip 172, 174 to cause the adjacent belt drive system 135 of the adjacent carriage 130 to rotate the belt 132 in the first or second direction. Based upon the control signal generated by the belt controller system 180, the circuit board 170 may direct or apportion the received power to the first and/or second power strips 172, 174 such that the first and/or second power strips 172, 174 direct or conduct a first power with a first polarity or a second power with a second polarity, such as with a revered or opposite polarity from the first power. The power conducted by the first and/or second power strips 172, 174 may be received by one or both of the first and second power receivers 158, 160. The first and/or second power receivers 158, 160 may direct the received power to the belt drive motor 136 which rotates the belt 130 in the first or second direction based upon the power received, such as based upon the polarity, power level, etc. In some embodiments, the belt controller system 180 generates an output which causes the select circuit boards 170 to output power with either a first or second polarity and the belt drive system 135 of the adjacent carriage 130 rotates the belt 132 in the first direction when the belt drive motor 136 receives power with the first polarity and rotates the belt 132 in the second direction when the belt drive motor 136 receives power with the second polarity.

Alternatively, the package conveying system 186 and/or the belt controller system 180 may generate a control signal or command which causes the power source 126 to direct power a first power, such as with a first power level or first polarity, to one or more circuit boards 170 and power at a second power, such as with a second power level or second polarity, to one or more circuit boards 170 and the circuit boards 170 direct the received power to the first and/or second power strip 172, 174 based upon the power received. In such embodiment, the power source 126 may be split into two sub-power sources such that a first sub-power source may transmit power at a first power level and a second sub-power source may transmit power at a second level.

In some embodiments, the package conveying system 186 may generate a control signal or command which causes the power source 126 and/or the first and second power strips 172, 174 to output a variable power with differing or varying power levels and the belt drive system 135 of the adjacent carriage(s) 130 may rotate the belt(s) 132 in the first and/or second directions at varying speeds based upon the power level received by the belt drive motor(s) 136. As such, the belt controller system 180 may control the direction and movement speeds of the belts 132 defining the conveying surface 128.

First and second power takeups 154, 156 may direct the power from the first and second power strips 172, 174, respectively, to the belt drive motor 136 of one of the carriages 130 defining the conveying surface 128. Based upon the power received, such as based upon the polarity or power level received, the belt drive motor 136 may actuate the corresponding belt drive shaft 138 in either the first direction or the second direction at differing speeds, thereby actuating the belt drive roller 140 in the first or second direction via the drive connector 146. The actuation of the belt drive roller 140 may then actuate or rotate the belt 132 of the carriage 130 in the first or second direction based upon the received power level such that one or more packages disposed on the top surface of the belt 132 are moved in the first or second direction, such as toward one of the chutes 124 of the sorter system 100.

Further, in some embodiments, the belt controller system 180 may generate an output which controls the speed or direction of the conveying surface 128 between the proximal and distal ends 104, 106. For example, the belt controller system 180 may be coupled to the carriage drive system 112 and may generate an output which causes the motor 114 and/or drive shaft 116 to adjust the actuation speed or direction of the carriages 130 such that relative speed of the conveying surface 128 is reduced or increased or such that the conveying surface 128 conveys packages from the distal end 106 toward the proximal end 104.

The belt controller system 180 may optionally be coupled with a user interface 192 containing a database with information related to the packages, such as shipping or chute destinations, and which may be updated by a user. For example, the database may include information related to packages, such as the destination or other shipping information, contents, etc. of the package. The storage 188 may be updated from based upon inputs from a user in the user interface 192. The user interface 192 may also be configured such that a user may selectively control the operation or actuation of the sorter system 100 in real time or near real time.

The sorter system 100 may also include one or more networks 194 in data communication with the belt controller system 180, the sensors 190, and/or the user interface 192. Each network 194 may be any suitable wired or wireless communication system which may permit data communication between devices, computers, processors, hardware components, or other suitable components. For example, each network 194 may be the Internet, intranet, wire connection, or any other suitable means for enable operable communication between devices, computers, processors, hardware components, or other suitable components.

The sorter system 100 may also be combined with one or more other sorter systems 100 such that an object or package may move along the conveying surface 128 of a first sorter system 100 and then along the conveying surface 128 of a second sorter system 100 and so on. The frames 102 of the conveyor systems 100 may be connected or otherwise attached together via fasteners, such as screws, nuts, and bolts. However, it will be appreciated that the two sorter systems 100 may be attached via other suitable means, such as welding, magnets, or adhesives.

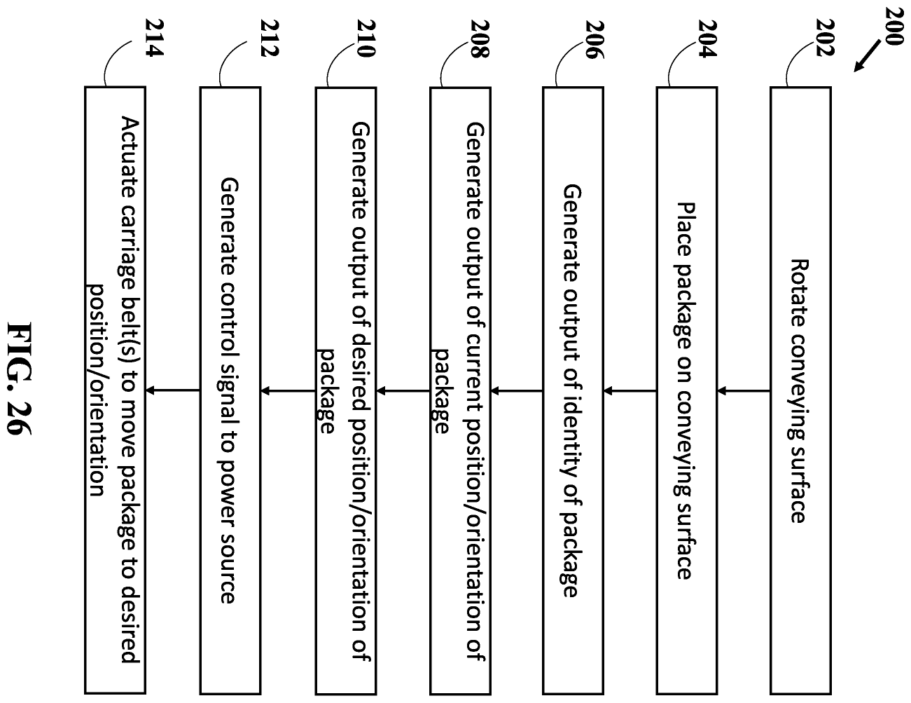

FIG. 26 illustrates an exemplary methodology relating to package sorting in a sorter system. While the methodology is shown as being a series of acts that are performed in a sequence, it is to be understood hat the methodology is not limited by the order of the sequence. For example, some acts can occur in different orders than what is described herein. In addition, an act can occur concurrently with another act. Further, in some instances, not all acts may be required to implement the methodology described herein.

Moreover, the acts described herein may be computer-readable instructions that can be implemented by one or more processors and/or stored on a computer-readable medium or media. The computer-executable instructions can include a routine, a sub-routine, programs, a thread of execution, and/or the like. Still further, results of acts of the methodology can be stored in a computer-readable medium displayed on a display device, and/or the like.

At 202, the conveying surface of a sorter system is rotated. As described above, a motor may be actuated such that a plurality of carriages move or otherwise rotate around tracks within the sorter system such that a conveying surface at a top of the sorter system moves, such as from a proximal end of the sorter system to a distal end of the sorter system. The belts of the carriages disposed in an upper portion of the tracks may at least partially define the conveying surface.

At 204, one or more packages are placed or otherwise disposed on the conveying surface of the sorter system. The packages may be disposed on the conveying surface at any position extending along a length of the conveying surface between the proximal and distal ends of the sorter.

At 206, an output is generated indicative of the identity of one or more packages. As described above, a package conveying system of a belt controller system may determine identifying information related to a package based on an output of one or more sensors, such as a sensed label or tag related to the package. The package conveying system may assign a destination location, such as a destination chute, to the package.

At 208, an output is generated indicative of the position, location, and/or orientation of one or more packages on the conveying surface. As described above, the package conveying system of the belt controller system may determine a current position, location, and orientation of the package relative to the moving conveying surface and relative to the sorter system based on an output of one or more sensors.

At 210, an output is generated indicative of a desired position, orientation, or location of the package. As described above, the package conveying system may determine the desired position, orientation, or location of the package as the destination chute or as an intermediate position and orientation on the conveying surface to increase the resolution of packages on the conveying surface, decrease the carriages the package is disposed across, decrease the actuation required to move the package into a chute, decreases the number of carriages a package is disposed across, aligns the package on the conveying surface, and/or the like.

At 212, a control signal is generated and transmitted to the power source and/or one or more circuit boards. As described above, the belt controller system may generate the control signal which selectively causes first and/or second power strips of circuit boards to be powered at a first power, such as with a first power level or a first polarity, or a second power, such as with a second power level or a second polarity opposite the first polarity. The power source may transmit power to the select circuit boards and the belt controller system may generate a control signal causing each of the circuit boards to direct the received power to the first and/or second power strips such that the power strips conduct the first or second power, or the belt controller system may generate a control signal causing the power source to transmit the first or second power to the select circuit boards and, based upon the power received, the circuit boards direct the received power to the first and/or second power strips.

At 214, the belts of one or more carriages may be actuated to direct or otherwise move the package to the desired position, location, or orientation. As described above, the first and/or second power strips are powered with the first or second power. The power is transferred from the circuit board to the corresponding carriage such that a belt drive motor causes the belt of the carriage to rotate. The belt drive system may rotate the belt in a first direction when the first power with the first polarity is received by the belt drive motor and may rotate the belt in a second direction opposite the first direction when the second power with the second polarity is received by the belt drive motor. Additionally, the belt drive system may rotate the belt at varying speeds based upon the power level received by the belt drive motor. Based upon the actuation of one or more belts in the first and second directions, the package may be moved to the desired position, orientation, and/or location, such as to the destination chute.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, alternatives as to form, fit, and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein.

Additionally, even though some features, concepts, or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated.

Moreover, while various aspects, features and concepts may be expressly identified herein as being inventive or forming part of a disclosure, such identification is not intended to be exclusive, but rather there may be inventive aspects, concepts, and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

1. A sorter system for sorting a package, the sorter system comprising:
a frame with frame sides extending from a proximal end to a distal end;
a track disposed between the frame sides in a looped configuration between the proximal end to the distal end;
a plurality of carriages disposed on the track, each carriage comprising;
a belt drive motor connected to a belt drive shaft;
a belt drive roller;
first and second belt support rollers;
a belt disposed around the belt drive roller, the first belt support roller, and the second belt support roller; and
first and second power receivers configured to direct power to the belt drive motor;
a carriage power system including a plurality of circuit boards each including a first power strip and a second power strip, the first power strip being configured to contact the first power receiver of the carriage passing thereon and the second power strip being configured to contact the second power receiver of the carriage passing thereon; and
a belt controller system configured to generate a control signal to selectively power the first or second power strip of one of the circuit boards;
wherein the belt drive motors rotate the belt in a first direction when powered by a first power and rotate the belt in a second direction when powered by a second power.

2. The sorter system according to claim 1, further comprising a plurality of chutes disposed on each side of the conveying surface.

3. The sorter system according to claim 1, wherein the belt controller system is remote from the carriages.

4. The sorter system according claim 1, wherein the first and second power receivers are roller bearings.

5. The sorter system according to claim 1, wherein each carriage further comprises a first power takeup electrically connecting the first power receiver and the belt drive motor and a second power takeup electrically connecting the first power receiver and the belt drive motor; wherein the first and second power takeups are conductive brushes.

6. The sorter system according to claim 1, wherein each belt drive roller includes an outer circumference and a belt receiving channel, the belt receiving channel configured to receive a drive connector coupling the belt drive roller and the belt drive shaft, and the outer circumference having a diameter larger than a diameter of the belt receiving channel.

7. The sorter system according to claim 1, wherein the carriages have a width of about 6 inches and the belts have a width of about 5 inches.

8. A belt drive system for a carriage of a sorter system, the belt drive system comprising:
a belt drive motor coupled to a belt drive shaft;
a belt drive roller including an outer circumference and a belt receiving channel;
a drive connector at least partially disposed around the drive belt shaft and received in the belt receiving channel;
first and second belt support rollers disposed at an upper portion of the carriage;
first and second power takeups configured to direct energy to the belt drive motor; and
a belt disposed around the belt drive roller, the first belt support, and the second belt support;
wherein the belt drive motor actuates the belt drive shaft in a first direction when energized by the first power takeup and actuates the belt drive shaft in a second direction when energized by the second power takeup.

9. The belt drive system according to claim 8, wherein the outer circumference of the belt drive roller is disposed on both sides of belt receiving channel.

10. The belt drive system according to claim 8, further comprising a third belt support roller configured such that the belt extends horizontally between the first and second belt support rollers.

11. The belt drive system according to claim 8, wherein the outer circumference of the belt drive roller includes a plurality of ribs.

12. The belt drive system according to claim 8, further comprising a first power receiver in electrical connection with the first power takeup and a second power receiver in electrical connection with the second power takeup; wherein the first power receiver is configured to roll along and conduct power from a first power strip and the second power receiver is configured to roll along and conduct power from a second power strip.

13. The belt drive system according to claim 8, wherein the belt drive motor is a brushed DC motor.

14. The belt drive system according to claim 8, wherein the belt drive roller is disposed parallel to the belt drive motor and the belt drive shaft, and the belt drive roller, belt drive motor, and belt drive shaft are connected to a belt drive frame.

15. A power system for a sorter system including a plurality of carriages with belts, the power system:
a power source;
a plurality of power sections electrically coupled with the power source and extending along a conductive track between side frames of the sorter system, each power section comprising a circuit board with a first power strip and a second power strip; and
a belt controller system configured to selectively cause a first power level to be directed to the first power strips and a second power level to be directed to the second power strips;
wherein each first power strip is configured to direct the first power level to one of the carriages passing thereon to actuate the belt of the carriage in a first direction and each second power strip is configured to direct the second power level to one of the carriages passing thereon to actuate the belt of the carriage in a second direction opposite the first direction.

16. The power system according to claim 15, wherein the power source conducts power to the plurality of power sections and the belt controller system is configured to control each circuit board to direct the power to the first or second power strip.

17. The power system according to claim 15, wherein the belt controller system is coupled to the power source and is configured to cause the power source to selectively direct first or second power levels to each of the powered sections; and wherein the circuit boards are each configured to direct the first power level to the first power strip and the second power level to the second power strip.

18. The power system according to claim 15, wherein each power section further comprises a cover which protects the first and second power strips.

19. The power system according to claim 15, wherein the power source is configured to generate 24 volt DC power.

20. The power system according to claim 15, wherein the belt controller system controls the first and second power levels based upon contents of a conveying surface of the sorter system.
